(19) United States
(12) Patent Application Publication
(10) Pub. No.: US 2026/0225525 A1
(43) Pub. Date: Aug. 6, 2026

(54) TARGETED MONITORING OF VEHICLE ENVIRONMENT FOR AUDIO

(71) Applicant: Volvo Car Corporation, Göteborg (SE)

(72) Inventors: Justin Gehling, Ridgeville, SC (US); Peter Laietta, III, Ridgeville, SC (US); Benjamin Carey Williams, Ridgeville, SC (US); Allison White, Ridgeville, SC (US)

(21) Appl. No.: 19/043,750

(22) Filed: Feb. 3, 2025

(51) Int. Cl. B60Q 9/00; G06F 3/16; H04N 7/18; H04R 1/40; H04R 3/00

(52) U.S. Cl. CPC B60Q 9/00; G06F 3/167; H04R 1/406; H04R 3/005; H04R 2499/13

(57) ABSTRACT

A system for dynamic tracking of sounds in a vicinity of a vehicle includes at least one memory storing instructions. Execution of the instructions cause one or more processors to determine, based on signals communicated from vehicle environmental sensors, a current position of a source of a sound relative to the vehicle and to indicate via at least one non-auditory interface of the vehicle the current position of the source of the sound relative to the vehicle. Execution of the instructions also cause the processor(s) to determine an updated position of the source of sound relative to the vehicle based a predicted change in the position of the sound source, a sensed change in the position of the source of sound, or both and to indicate via the non-auditory interface(s) of the vehicle the updated position of the source of sound relative to the vehicle.

### INTRODUCTION

The present disclosure relates generally to the automotive field. More particularly, the present disclosure relates to supplementing audio signals encountered during use of a vehicle for an occupant, especially targeted monitoring or dynamic tracking of sounds in the vicinity of the vehicle.

Operators of vehicle often use sound either consciously or subconsciously to make determinations with respect to how to operate the vehicle or the current condition of the vehicle or its components. However, some operators have difficulty hearing such sounds because of hearing impairments, loud cabin environments, or the like. Current vehicles are generally incapable of providing substitute auditory signals capable of fully or partially replacing normal auditory feedback. Furthermore, current vehicles do provide dynamic tracking of sound sources in the vicinity of the vehicle so that the operator may respond in real time.

As such, a need exists in the art for a system and associated methods and control systems for vehicles that overcome the above limitations. This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide a system for dynamic tracking of sounds in a vicinity of a vehicle and associated methods of operation and control systems that overcome the limitations of the known art.

Embodiments of the disclosed systems and methods facilitate monitoring for specific external noises relevant to operation of the vehicle and providing dynamic non-audio indicators representing details about the noises such as the positions and/or characteristics of the causes of the sounds. Generally, environmental data provided from one or more vehicle environmental sensors is utilized to determine the current position of a sound source and sensed or predicted changes in the position of the sound source. One or more non-auditory interfaces of the vehicle such as screens, touch screens, head-up displays, instrument panels, haptic feedback devices, or the like are utilized to indicate the current position of the sound source, a sensed updated position of the sound source, a predicted updated position of the sound source, or a combination thereof in real-time such that an operator unable to hear the sound may react in a suitable fashion. In an exemplary embodiment, a suitable schematic representation is displayed including an indicator illustrating the position of the source of sound relative to the vehicle. The indicator may be updated based on sensed or predicted changes in the position or characteristics of the sound or source of sound. Alternatively, additional indicators may be generated based on such updates such that a route of the source of sound and/or previous characteristics of the sound are indicated. Furthermore or in different embodiments, video feeds of the current position of the source of sound, the updated position of the source of sound, and/or a predicted next position of the source of sound may be provided by the same or different non-auditory interfaces in addition to or as an alternative to the schematic representation including the indicator. Such video feeds may also be updated dynamically and/or in real time such that an operator unable to hear the sound may react in a suitable fashion.

To achieve the foregoing and other objects and advantages, in one aspect, the present subject matter is directed to a system for dynamic tracking of sounds in a vicinity of a vehicle includes at least one memory storing instructions. Execution of the instructions by one or more processors cause the processor(s) to determine, based on signals communicated from a plurality of environmental sensors supported relative to the vehicle, a current position of a source of a sound relative to the vehicle. The instructions further cause the processor(s) to indicate via at least one non-auditory interface of the vehicle the current position of the source of the sound relative to the vehicle. Execution of the instructions also cause the processor(s) to determine an updated position of the source of sound relative to the vehicle based on at least one of a predicted change in the position of the sound source or a sensed change in the position of the source of sound. The instructions additionally cause the processor(s) to indicate via the at least one non-auditory interface of the vehicle the updated position of the source of sound relative to the vehicle.

In at least one embodiment, the plurality of environmental sensors includes at least one of a microphone, an acoustic sensor, a vibrational sensor, a camera, or an optical sensor. In some such embodiments or different embodiments, the signals communicated from the plurality of environmental sensors may indicate sounds or audio data communicated from at least one of a microphone, an acoustic sensor, or a vibrational sensor. Additionally or alternatively, the at least one non-auditory interface may include at least one of a haptic feedback device on a steering wheel of the vehicle, an infotainment display of the vehicle, an instrument panel of the vehicle, or a heads-up display of the vehicle. In an additional or alternative embodiment, the instructions may further cause the processor(s) to identify that the source of sound is within the vicinity of the vehicle based on signals communicated from at least one environmental sensor of the plurality of environmental sensors. Additionally or alternatively, the current position of the sound source may be determined based on signals communicated from at least one additional environmental sensor of the plurality of environmental sensors with respect to the at least one environmental sensor utilized to identify that the source of sound is within the vicinity of the vehicle. In an additional or alternative embodiment, the instructions may further cause the processor(s) to select, based on the signals communicated from the plurality of environmental sensors, the sound from a plurality of sounds in the vicinity of the vehicle. In some such embodiments or different embodiments, the sound may be selected based on at least one of an importance of an event associated with generation of the sound or the source of sound.

In an additional or alternative embodiment, the instructions may further cause the processor(s) to display via a first media element and the at least one non-auditory interface at least one video feed of the vicinity of the vehicle. Additionally or alternatively, indicating the current position of the source of sound relative to the vehicle may include displaying via a second media element and the at least one non-auditory interface at least one video feed indicating the current position of the source of sound relative to the vehicle in more detail than the at least one video feed of the vicinity of the vehicle. Additionally or alternatively, indicating the updated position of the source of sound relative to the vehicle may include displaying via the second media element and the at least one non-auditory interface an additional video feed indicating the updated position of the sound source relative to the vehicle in more detail than the at least one video feed of the vicinity of the vehicle.

In an additional or alternative embodiment, the instructions may further cause the processor(s) to display via the second media element and the at least one non-auditory interface at least one video feed indicating a previously determined position of the source of sound relative to the vehicle in more detail than the at least one video feed of the vicinity of the vehicle. In further or different embodiment, the instructions may further cause the processor(s) to determine, subsequent to determining the updated position of the source of sound based on the sensed change in the position of the source of sound, a further updated position of the source of sound relative to the vehicle based on at least one of a further predicted change in the position of the sound source or a further sensed change in the position of the source of sound. Additionally or alternatively, the instructions may further cause the processor(s) to replace the additional video feed of the second media element indicating the previously determined updated position of the sound source relative to the vehicle with a further video feed indicating the further updated position of the sound source relative to the vehicle in more detail than the at least one video feed of the vicinity of the vehicle. Additionally or alternatively, the instructions may further cause the processor(s) to replace the at least one video feed of the second media element indicating the previously determined current position of the source of sound relative to the vehicle with the additional video feed indicating the previously determined updated position of the sound source relative to the vehicle. Additionally or alternatively, the instructions may further cause the processor(s) to display via the second media element and the at least one non-auditory interface the at least one video feed indicating the previously determined current position of the source of sound relative to the vehicle.

Additionally or alternatively, indicating the current position of the source of sound relative to the vehicle may include generating, based on the determined current position of the source of the sound source, an indicator via the non-auditory interface of the vehicle, the indicator indicating the determined current position of the source of sound relative to the vehicle. In additional or alternative embodiments, indicating the updated position of the source of sound relative to the vehicle may include updating the indicator provided by the non-auditory interface of the vehicle such that the updated indicator indicates at least one of a predicted updated position of the sound source relative to the vehicle or a sensed updated position of the sound source relative to the vehicle. Additionally or alternatively, the updated indicator may indicate that the source of sound is at least one of an emergency vehicle, a horn of another vehicle, or a motorcycle. In some such embodiments or different embodiments, the instructions may further cause the processor(s) to generate the predicted updated position of the sound source based at least in part on the determined current position of the source of sound and a determined previous position of the source of sound. Additionally or alternatively, wherein the indicator may be updated based, at least in part, on the predicted updated position of the sound source. In an additional or alternative embodiment, the instructions may further cause the processor(s) to generate the sensed updated position of the sound source based at least in part on subsequent signals communicated from the plurality of environmental sensors.

In an additional or alternative aspect, the present subject matter is directed to a vehicle including a plurality of environmental sensors supported relative to the vehicle and at least one memory storing instructions configured to dynamically track sounds in a vicinity of the vehicle. Execution of the instructions by one or more processors cause the processor(s) to determine, based on signals communicated from a plurality of environmental sensors supported relative to the vehicle, a current position of a source of a sound relative to the vehicle. The instructions further cause the processor(s) to indicate via at least one non-auditory interface of the vehicle the current position of the source of the sound relative to the vehicle. Execution of the instruction also causes the processor(s) to determine an updated position of the source of sound relative to the vehicle based on at least one of a predicted change in the position of the sound source or a sensed change in the position of the source of sound. The instructions additionally cause the processor(s) to indicate via the at least one non-auditory interface of the vehicle the updated position of the source of sound relative to the vehicle.

In at least one embodiment, the instructions may further cause the processor(s) to display via a first media element and the at least one non-auditory interface at least one video feed of the vicinity of the vehicle. Additionally or alternatively, indicating the current position of the source of sound relative to the vehicle may include displaying via a second media element and the at least one non-auditory interface at least one video feed indicating the current position of the source of sound relative to the vehicle in more detail than the at least one video feed of the vicinity of the vehicle. Additionally or alternatively, indicating the updated position of the source of sound relative to the vehicle may include displaying via the second media element and the at least one non-auditory interface an additional video feed indicating the updated position of the sound source relative to the vehicle in more detail than the at least one video feed of the vicinity of the vehicle.

In an additional or alternative embodiment, indicating the current position of the source of sound relative to the vehicle may include generating, based on the determined current position of the source of the sound source, an indicator via the non-auditory interface of the vehicle, the indicator indicating the determined current position of the source of sound relative to the vehicle. In additional or alternative embodiments, indicating the updated position of the source of sound relative to the vehicle may include updating the indicator provided by the non-auditory interface of the vehicle such that the updated indicator indicates at least one of a predicted updated position of the sound source relative to the vehicle or a sensed updated position of the sound source relative to the vehicle.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the companying drawings, in which:

FIG. 1 illustrates a schematic diagram of an exemplary embodiment of a vehicle including or suitable for use with a system for dynamic tracking of sounds in a vicinity of a vehicle, in accordance with aspects of the present subject matter;

FIG. 2 illustrates a schematic logic diagram of an exemplary embodiment of a system for dynamic tracking of sounds in a vicinity of a vehicle, in accordance with aspects of the present subject matter;

FIG. 3A illustrates an exemplary embodiment of a method including method elements, one or more of which may be implemented in a method for dynamic tracking of sounds in a vicinity of a vehicle, in accordance with aspects of the present subject matter;

FIG. 3B illustrates an exemplary embodiment of a method including additional or alternative method elements, one or more of which may be implemented in a method for dynamic tracking of sounds in a vicinity of a vehicle, in accordance with aspects of the present subject matter;

FIG. 3C illustrates an exemplary embodiment of a method including additional or alternative method elements, one or more of which may be implemented in a method for dynamic tracking of sounds in a vicinity of a vehicle, in accordance with aspects of the present subject matter;

FIG. 4A illustrates an exemplary embodiment of a display of a non-auditory interface depicting indicators, in accordance with aspects of the present subject matter;

FIG. 4B illustrates an exemplary embodiment of a dynamic display of a non-auditory interface depicting indicators, in accordance with aspects of the present subject matter;

FIG. 4C illustrates an exemplary embodiment of a dynamic display of a non-auditory interface depicting indicators including video feeds, in accordance with aspects of the present subject matter;

FIG. 4D illustrates another exemplary embodiment of a dynamic display of a non-auditory interface depicting indicators including video feeds, in accordance with aspects of the present subject matter;

FIG. 4E illustrates another exemplary embodiment of a dynamic display of a non-auditory interface depicting indicators including video feeds, in accordance with aspects of the present subject matter;

FIG. 5 illustrates a schematic diagram of an exemplary embodiment of a network of a cloud-based system for implementing various cloud-based services, in accordance with aspects of the present subject matter;

FIG. 6 illustrates a schematic diagram of an exemplary embodiment of a server which may be used in the cloud-based system of FIG. 5 or stand-alone, in accordance with aspects of the present subject matter; and

FIG. 7 illustrates a schematic diagram of an exemplary embodiment of a user device which may be used in the cloud-based system of FIG. 5 or stand-alone, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, embodiments of the disclosed systems and methods facilitate monitoring for specific external noises relevant to operation of the vehicle and providing dynamic non-audio indicators representing details about the noises such as the positions and/or characteristics of the causes of the sounds. Generally, environmental data provided from one or more vehicle environmental sensors is utilized to determine the current position of a sound source and sensed or predicted changes in the position of the sound source. One or more non-auditory interfaces of the vehicle such as screens, touch screens, head-up displays, instrument panels, haptic feedback devices, or the like are utilized to indicate the current position of the sound source, a sensed updated position of the sound source, a predicted updated position of the sound source, or a combination thereof in real-time such that an operator unable to hear the sound may react in a suitable fashion. In an exemplary embodiment, a suitable schematic representation is displayed including an indicator illustrating the position of the source of sound relative to the vehicle. The indicator may be updated based on sensed or predicted changes in the position or characteristics of the sound or source of sound. Alternatively, additional indicators may be generated based on such updates such that a route of the source of sound and/or previous characteristics of the sound are indicated. Furthermore or in different embodiments, video feeds of the current position of the source of sound, the updated position of the source of sound, and/or a predicted next position of the source of sound may be provided by the same or different non-auditory interfaces in addition to or as an alternative to the schematic representation including the indicator. Such video feeds may also be updated dynamically and/or in real time such that an operator unable to hear the sound may react in a suitable fashion.

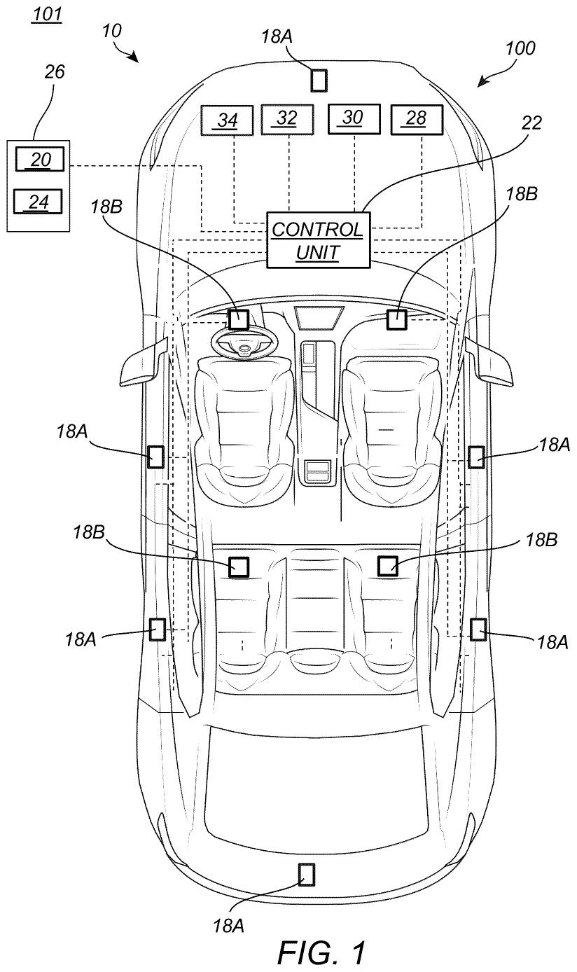

Referring now generally to FIG. 1, a schematic diagram of an exemplary embodiment of a system for supplementing audio signals for an occupant of a vehicle and/or dynamic tracking of sounds in a vicinity of a vehicle is illustrated in accordance with aspect of the present subject matter. As shown, a vehicle 10 may generally include a system 100 for supplementing audio signals for an occupant of the vehicle 10 and/or dynamic tracking of sounds in a vicinity of the vehicle 10. As used herein, dynamic may refer to in real time and/or contemporaneously. For example, dynamic processes as described herein may have similar response times as antilock braking systems and/or traction control systems for vehicles. In practice, the response time of such processes are considered to be dynamic, in real-time, or the like, despite a minimal or nominal processing time, such as less than a second, a less than half a second, etc. Particularly, the system 100 and/or vehicle 10 may be configured to monitor a vicinity surrounding the vehicle 10 or the cabin of the vehicle 10, especially for auditory signals, sounds, or the like.

The vicinity of the vehicle 10 generally includes range or external environment around the vehicle 10 which may be auditorily monitored via appropriate sensors of the vehicle 10 and/or system 100. In various embodiments any sound sensed or determined at the vehicle 10 above the audible human range may be associated with a sound source considered to be within the vicinity (e.g., a dynamic vicinity) of the vehicle 10 and particularly suitable for audio signal supplementation and/or dynamic tracking. Thus, a generally quiet sound close to the vehicle 10 may be outside of the vicinity of the vehicle while a relatively louder sound father from the vehicle 10 may be considered to be within the vicinity of the vehicle 10. The vicinity and/or external environment of the vehicle 10 may be a predetermined range such as less than 25 feet, such as less than 100 feet, such as less than 150 feet, such less than 300 feet. Additionally or alternatively, the vicinity and/or external environment of the vehicle 10 may be determined based on the external environment surrounding the vehicle 10 and/or a real-time ability of suitable sensors of the vehicle to determine the external environment surrounding the vehicle 10, especially with respect to sounds, auditory signals, and the like. Such vicinity and/or external environment of the vehicle 10 may be determined utilizing one or more appropriate artificial intelligence algorithms and based on external environmental data, especially sound or vibrational data. Generally, the vicinity and/or external environment of the vehicle 10 may also be based, at least in part, on a detectable range of one or more external vehicle sensors 18A. For instance, the vicinity and/or external environment of the vehicle 10 may be limited by at least an external vehicle sensor 18A having the furthest accurate range of measurement, e.g., a predetermined accurate range or an accurate range determined based on the environmental context surrounding the vehicle 10.

As further illustrated in FIG. 1, the vehicle 10 and/or system 100 includes one or more environmental sensors 18, such as external environmental sensor(s) 18A and/or internal or cabin environmental sensor(s) 18B. Various configurations of vehicles include additional, fewer, or alternatively placed environmental sensors 18. Generally, the environmental sensors 18 may include one or more microphones, acoustic sensors, vibrational sensors, or the like suitable to capture data indicative of audible sound in the external environment and/or cabin of the vehicle 10. It should be appreciated that, in some embodiments of the vehicle 10 and/or system 100, the environmental sensors 18 may additionally or alternatively include one or more cameras, LiDAR sensors, radar sensors, proximity sensors, impact sensors, infrared sensors, optical sensors, seat sensor(s), or other sensors utilized or not utilized in conjunction with the system 100. In some embodiments and as shown, the environmental sensor(s) 18 may include the internal environmental sensor(s) 18B, such as a cabin sensor.

Additionally or alternatively, the external environmental sensor(s) 18A may include one or more of a front sensor configured to capture data indicating a portion of the external environment of the vehicle 10 associated with a front bumper of the vehicle 10, a rear sensor configured to capture data indicating a portion of the external environment of the vehicle 10 associated with a rear bumper of the stowed vehicle 10, a driver-side sensor configured to capture data indicating a portion of the external environment of the vehicle 10 associated with a driver side of the vehicle 10, a passenger-side sensor configured to capture data indicating a portion of the external environment of the vehicle 10 associated with a passenger side of the vehicle 10, a front-driver-corner sensor configured to capture data indicating a portion of the external environment of the vehicle 10 associated with a front-driver corner of the vehicle 10, a front-passenger-corner sensor configured to capture data indicating a portion of the external environment of the vehicle 10 associated with a front-passenger corner of the vehicle 10, a rear-driver-corner sensor configured to capture data indicating a portion of the external environment of the vehicle 10 associated with a rear-driver corner of the vehicle 10, or a rear-passenger-corner sensor configured to capture data indicating a portion of the external environment of the vehicle 10 associated with a rear-passenger corner of the vehicle 10. For example, the vehicle 10 and/or system 100 may include a microphone, an acoustic sensor, a vibrational sensor, or the like at one or multiple of these locations. Similarly, the vehicle 10 and/or system 100 may additionally or alternatively include other sensors, such as one or more optical sensors, at one or multiple of these locations or different locations. In some embodiments the external environmental sensors 18A may include a birds-eye-view camera, an omnidirectional microphone, or the like configured to indicate the environmental context of the general vicinity and/or in multiple directions. Any of these sensors or other dedicated sensors may be positioned and/or configured to monitor specific components of the vehicle 10 (e.g., tires, brakes, the engine, etc.), especially for the production of sound.

The vehicle 10 and/or system 100 include one or more memory devices storing instructions that, when executed by one or more processors, cause the processor(s) to carry out one or more logical steps or method elements for supplementing audio signals for an occupant of a vehicle, as described herein. In some embodiments and as shown, the vehicle 10 and/or system 100 may further include a control unit 22 (e.g., an electronic control unit, multiple associated control units, and/or a combination of one or more processing devices and at least one memory or memory device as described herein) communicatively coupled to one or more of the environmental sensor(s) 18, one or more external device(s) 26 such a mobile device 20 of the operator/owner, and/or other components of the vehicle 10 and/or system 100, described in more detail in the following description. The control unit 22 may be configured to direct operation of one or more of such components in accordance with aspects of the present subject matter.

While a single control unit 22 is illustrated in FIG. 1 for simplicity, it should be appreciated that the control unit 22 may include multiple associated control units, electronic control units, processing devices, memory devices, or the like that together are configured to provide operational control of the vehicle 10, the system 100, the environmental sensor(s) 18, user interface components 32 of the vehicle 10, and/or other components of the vehicle 10 and/or system 100. The control unit 22 may additionally or alternatively facilitate communication between the vehicle 10, the system 100, the external device(s) 26, mobile device(s) 20, a remote device 24 (e.g., memory device, a server, a cloud system), the environmental sensor(s) 18, the external environment of the vehicle 10, the internal or cabin environment of the vehicle 10, and/or user interface components 32 (e.g., internal screens, touchscreens, displays, a steering wheel, haptic feedback devices, an infotainment display, a dashboard display, a heads-up display, or the like), or the like of the vehicle 10. Generally, the control unit 22 may be configured to receive a signal or data indicative of the environmental context surrounding the vehicle 10 and/or the environmental context of the cabin of the vehicle 10, especially sound, vibrations, acoustic signals, images, optical data, videos, video feeds, and the like. The control unit 22 may be configured to direct operation of one or more of such components in accordance with aspects of the present subject matter. In some embodiments, the external device(s) 26, the mobile device(s) 20, the remote device 24, and/or the cloud may function as a repository of stored data indicating or associated with previously analyzed sounds, occupant profiles, or occupant qualities.

In operation, the control unit 22 may determine characteristics or qualities of the occupant(s), identify sounds within the external environment and/or cabin of the vehicle, determine a position of a source of the sound and/or a quality of the sound, and generate one or more indicators via one or more non-auditory interface of the vehicle indicating the determined position of the sound source and/or the determined quality or characteristics of the sound or source of sound. Optionally, the control unit 22 may implement such a process in response to determining that an occupant of the vehicle 10 has a hearing impairment; in response to determining a cabin audio environment (e.g., sound intensity, sound pitch, or variety of sounds) of the vehicle 10 masks cabin or external audio sounds, signals, etc.; or in response to an interface prompt provided by the occupant of the vehicle 10 implementing such a system, method, or associated control logic. The control unit 22 may generally make any such determination based, at least in part, on the environmental data, especially sound or acoustic data, provided by the environmental sensors 18, such as external environmental or audio sensors, cabin environment or audio sensors, or a combination thereof. The determined quality or qualities of the sound may include one or more of an intensity of the sound, a defective tire of the vehicle, a siren of another vehicle, a horn of another vehicle, an impact of the vehicle, a vehicular collision within a vicinity of the vehicle, a faulty brake of the vehicle, or a malfunction of the vehicle or an associated component.

The indicator(s) provided via one or multiple of the non-auditory user interface components 32 may include distinct outputs for each type of such determined qualities and/or may indicate an associated degree of a quality, e.g., the indicator may represent louder sound intensity differently than a quiet sound intensity. The indicator may also provide information regarding whether the sounds source is external or internal (within the cabin), the type of sound source, or an importance of the source of sound. For example, sounds associated with failures of the vehicle 10 and/or its components or collisions may be highlighted or focused on relative to other sounds sources that are less important or critical to operation of the vehicle 10, e.g., an adjacent vehicle backfiring. In some instances, the source of the sound may include an impact on the vehicle 10 loud enough to be sensed by one or more of the environmental sensors 18 and/or indicated in signals communicated therefrom. Such impacts may include, without limitation, an impact from a moving vehicle, an impact from a grocery cart, an impact from a vehicle door, impacts from objects (e.g., baseball bats, tire irons, bird strikes, rocks on the windshield, hail impacts, etc.), or the like.

Furthermore, the control unit 22 may include or utilize one or more artificial intelligence (AI) programs to make some or all of such determinations or different determination. For example, a suitably trained AI program, subroutine, module, or the like may determine the occupant quality(ies), the appropriate external environment around the vehicle 10 to monitor, adjust the monitored external environment based on determined qualities of the external environment and/or the cabin of the vehicle 10, determine the one or more qualities of the sound, such as the type of sound or a likely cause of the sound, determine an importance of an event associated with the generation of a sound and/or the source of sound, select the sound for audio supplementation and/or dynamic tracking from multiple sources of sound, determine the position of the source of the sound relative to the vehicle 10 including whether the source is within the vehicle, is within the external environment of the vehicle, and/or is component of the vehicle, and or dynamically track a sound or source of sound for display to the occupant or operator of the vehicle 10.

Referring still to FIG. 1, the vehicle 10 generally includes a plurality of seats, seat assemblies, occupant suites, or the like. The number, position, and orientation of the components illustrated in FIG. 1 are provided as an example, and it should be appreciated that alternative embodiments of the vehicle 10 may include fewer, additional, or alternatively configured components so long as such components are suitable to implement the logical steps and/or method elements disclosed herein. For example, only a portion of the seat assemblies may be provided with certain cabin environmental sensors 18B, e.g., dedicated cabin microphone, camera, or the like, such as some but not all of the rear seats.

Furthermore, other embodiments of the vehicle 10 and/or system 100 may include or be associated with more, fewer, or differently positioned/oriented external environmental sensors 18A, cabin environmental sensors 18B, and/or the non-auditory interface(s) 32. Alternatively or additionally, doors of the vehicle 10 adjacent to one another may share one or more external environmental sensors 18A or even lack such components. Furthermore or alternatively, the one or more corners of the vehicle 10 may be provided with dedicated external environmental sensors 18A. Some embodiments of the vehicle 10 and/or system 100 may not include the front external environmental sensor 18A and/or the rear external environmental sensor 18A.

As shown, at least some of the previous occupants of vehicle 10, such as at least the operator or owner of the vehicle 10 may be associated with a mobile device 20 (e.g., a cellular phone, tablet, laptop, MP4/MP3 audio device, smart watch, smart glasses, wearable technology, or the like). Thus and in some embodiments, the environmental sensor(s) 18 may include one more receivers/transceivers suitable to establish a wired or wireless connection (e.g., a near-field connection, a local area network connection, a Wi-Fi connection, a Bluetooth connection, or the like) between the vehicle 10, the system 100, and/or an associated control unit 22 and the mobile device(s) 20 of the occupant(s), operator(s), owner(s), etc. Optionally, one or more of such connections may be provided, at least partially, through the cloud.

In some embodiments, the vehicle 10 may be an electric vehicle having electrical components (e.g., one or more electric motors, associated batteries, etc.) for propelling the vehicle 10. Additionally or alternatively, the vehicle 10 may be configured with a rear-mounted or front-mounted internal combustion engine (ICE). In other embodiments, the vehicle 10 may be configured as a hybrid vehicle, which is driven by both a petroleum product (e.g., gas, diesel, jet fuel, and the like) and electrical power. Some embodiments of the vehicle 10 may include autonomous capability of varying degrees. It will be appreciated that the exemplary vehicle(s) 10 depicted and described herein are by way of example only, and, in other exemplary embodiments, the vehicle 10 may have any other suitable configuration, including, for example, any other suitable number of rows of seats, rows of doors, etc. Similarly, the vehicle 10 may have any other suitable number and position of doors, external environmental sensors 18A, cabin environmental sensors 18B, and the like. Additionally or alternatively and in other exemplary embodiments, any other suitable power sources may be provided. For example, the vehicle 10 may include a liquid or gaseous hydrogen powered engine, a gas turbine engine, an inboard motor, an outboard motor, etc.

While embodiments of the vehicle 10 herein may be illustrated or described as an automotive vehicle, it should be appreciated that the present disclosure is equally applicable to any other form of transportation (e.g., trains, boats, busses, passenger rail cars, and the like) where supplementing audio signals for an occupant of a vehicle 10 and/or dynamic tracking of sounds (e.g., sound sources) is desired or required. Thus, regardless of the type of power train, design, or model of the vehicle 10, the vehicle 10 may include or be utilized with embodiments of the system 100, as described herein.

Generally, the control unit 22 may be configured to receive a signal or data indicative of an auditory, vibrational (e.g., vibrations associated with sound production), and/or acoustical external environment surrounding the vehicle 10 and/or the cabin of the vehicle 10. Based on such received signals or data or in response to, the control unit 22 may generally determine the position of the source of the sound relative to the vehicle 10 and/or the one or more qualities of the sound, as described herein. The control unit may be configured to thereafter generate the indicator indicating the determined position of the sound source relative to the vehicle 10 and/or the determined quality(ies) of the sound via the one or more of the non-auditory interfaces 32 of the vehicle 10. Furthermore and as shown in FIG. 1, the control unit 22 may receive vehicle parameters from various additional or alternative components of the vehicle 10 or components associated with the vehicle 10 to similarly provide operational control, feedback, or input information, as described in more detail below. In some embodiments, the control unit 22 may be configured to dynamically track changes in the position of the source of sound, such as updating the indicator and/or tracking the source of sound utilizing the most suitable cameras, optical sensors, etc. of the vehicle 10.

While some communication links in FIG. 1 may be illustrated as joint communication links, it should be appreciated that one or more components communicatively coupled to the control unit 22, such as all of the components, may have component dedicated communication links (e.g., wireless or wired communication links with the control unit 22).

By applying an appropriate algorithm in the control unit 22, the system 100 can be integrated with the rest of the vehicle systems, with input from/output to a vehicle power source 28 (e.g., one or more electric motors, ICE motors, or associated control systems, monitors, sensors, etc.), a vehicle power supply 30 (e.g., one or more batteries, gas tanks, or associated control systems, monitors, sensors, etc.), the non-auditory interface(s) 32 (e.g., screens, displays, or touch screens of an infotainment unit or system, an instrument panel of the vehicle 10, a heads-up display, and/or haptic feedback devices included in one or more components of the vehicle 10 such as the operator seat and/or the steering wheel of the vehicle 10), an audio system 34 (e.g., one or more control systems, amplifiers, preamplifiers, or the like), the environmental sensor(s) 18, the external device(s) 26, the mobile device(s) 20, and/or the remote device 24. In several embodiments, some of such devices, such as all of such devices, may each include or be associated with a suitable mobile application, a suitable cloud application, and/or a suitable application programming interface configured to provide external information and/or instructions to the control unit 22, from the control unit 22, or a combination thereof.

In some embodiments, besides controlling the operation of the vehicle 10, system 100, and/or included or associated components thereof, the control unit 22 may also provide useful information to the operator via the mobile device(s) 20 and/or user interface components 32, such as a display or touch screen thereof. Associated user interface(s) 32 may include one or more buttons, switches, touch screen capability, or the like allowing the operator/owner of the vehicle 10 to communicate inputs to the control unit 22 utilized to control operation of the vehicle 10, system 100, and/or components or subsystems thereof.

With respect to the external environmental sensor(s) 18A, such sensors 18A may generally be configured to communicate one or more signals suitable for the control unit 22 to determine qualities of the occupant, recognize sounds or noises within the external environment of the vehicle 10 and/or the cabin of the vehicle 10, determine a position of the source of sounds and the one or more qualities of the sound, and generation of the indicator. The signal(s) communicated from such sensor(s) 18A may further indicate the type of environment surrounding the stowed vehicle 10 (e.g., remote, urban, private property, parking lot, forest, planes, etc.); transitory conditions of the external environment surrounding the stowed vehicle 10 (e.g., weather, lighting conditions, wind direction, traffic density, etc.); external environmental sounds; cabin sounds; and/or characteristics of such sounds. With respect to the internal environmental sensor(s) 18B, such sensors 18B may generally be configured to communicate one or more signals suitable for the control unit 22 to determine, without limitation, that the vehicle 10 is occupied.

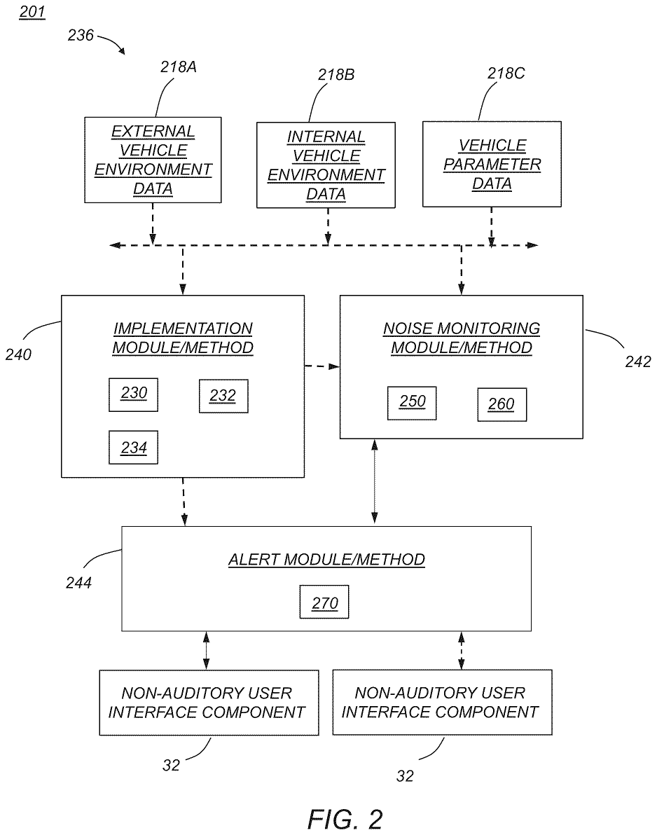

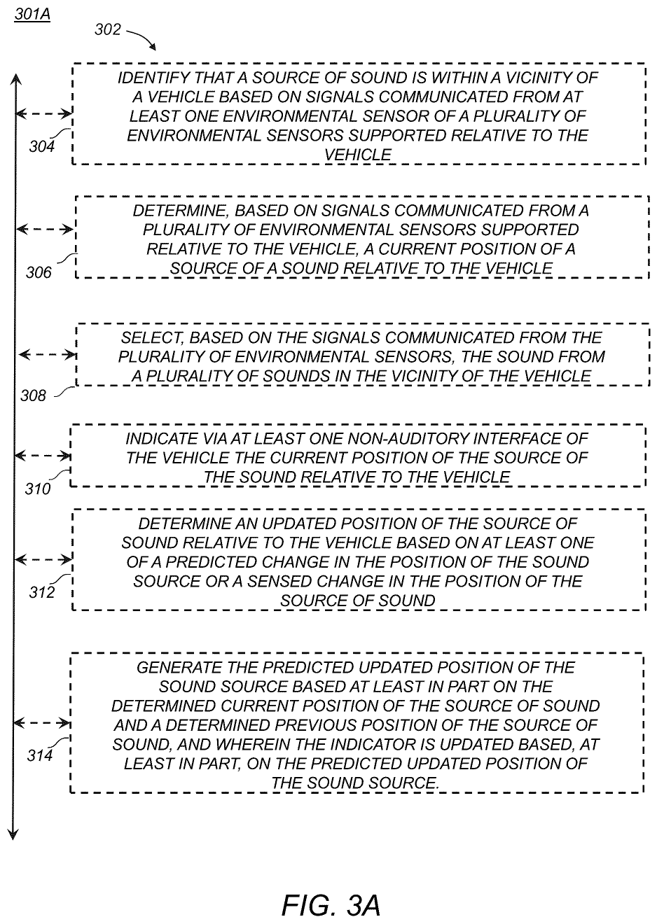

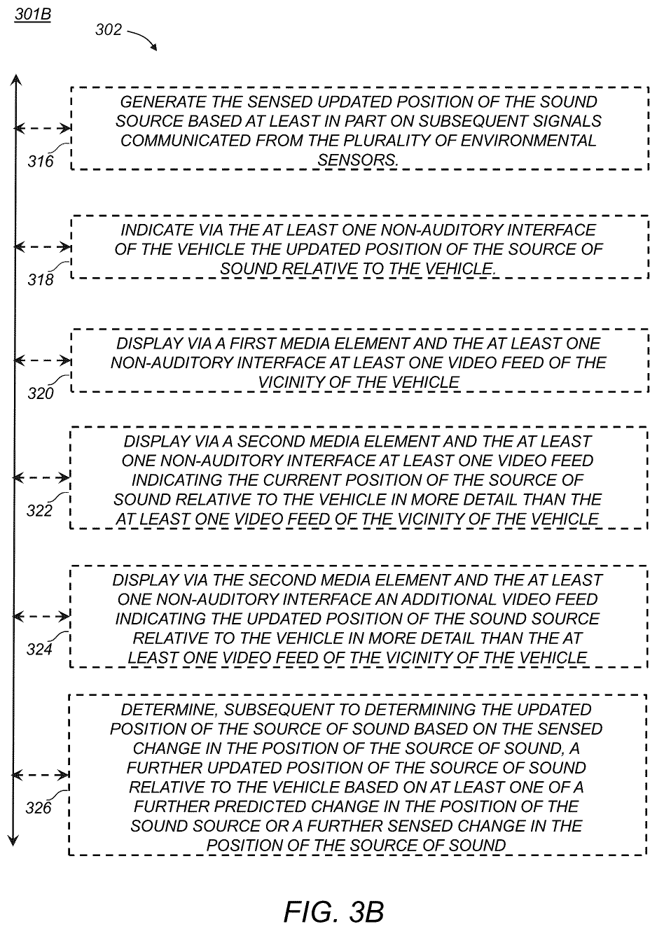

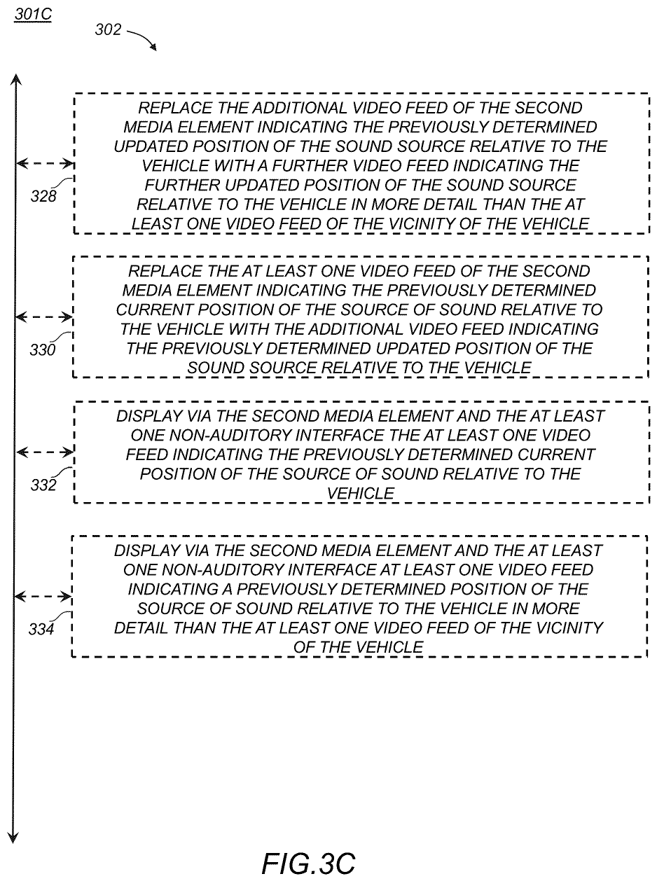

Referring now to FIGS. 2-3, FIG. 2 illustrates a schematic logic diagram of an exemplary embodiment of a system for supplementing audio signals for an occupant of a vehicle and/or dynamic tracking of sounds in the vicinity of the vehicle in accordance with aspects of the present subject matter; FIG. 3A illustrates method elements, one or more of which may be implemented in a method for dynamically tracking sounds in a vicinity of a vehicle in accordance with aspects of the present subject matter; FIG. 3B illustrates additional or alternative method elements, one or more of which may be implemented in a method for dynamically tracking sounds in a vicinity of a vehicle in accordance with aspects of the present subject matter; and FIG. 3C illustrates additional or alternative method elements, one or more of which may be implemented in a method for dynamically tracking sounds in a vicinity of a vehicle in accordance with aspects of the present subject matter.

The logic diagram depicted in FIG. 2 (control logic 236) and/or the method or process (method 302) depicted in one or more of FIGS. 3A, 3B, and/or 3C may be utilized to control or in association with embodiments of the vehicle 10 and/or the system 100 as described above with respect to FIG. 1, any of the components or subsystems thereof, such as the environmental sensor(s) 18, the control unit 22, the external device(s) 26, the mobile device(s) 20, the remote device(s) 24, vehicle power source(s) 28, the vehicle power supply(ies) 30, the user interface components 32 including the non-auditory user interface components, the audio system 34 (if not already included or embedded within control unit 22), other control systems or monitoring system of the vehicle 10, such as an electronic vehicle control system configured to provide general operational control of the vehicle 10, or other systems or components utilized in association with operation of the vehicle 10, such as navigation systems and/or a global positioning system, sensors, etc. However, it should be appreciated that the control logic 236 and/or the method 302 may be utilized to control or in association with embodiments of other similar or suitably configured vehicles, systems for supplementing audio signals for an occupant of a vehicle, systems for dynamic tracking of sounds in the vicinity of a vehicle, and/or components or subsystems thereof. The control logic 236 may include one or more modules including instructions stored in at least one memory and executable by one or more processors to cause the processor(s) to implement steps, method elements, or the like as described herein. For example, elements of the control logic 236 and/or method 302 may be implemented, at least in part, by the control unit 22 and stored in memory associated with the control unit 22 and/or included with or accessible by the vehicle 10.

The control logic 236 may include one or more modules such an implementation module 240, a noise monitoring module 242, an alert module 244, and/or multiple modules, submodules, subroutines, or the like suitable to execute at least one, some, or all of the elements of method 302 and/or logical equivalents. The modules 240, 242, 244 may include instructions stored in at least one memory and executable by one or more processors to cause the processor(s) to implement steps, method elements, or the like as described herein. For example, elements of the control logic 236 and/or method 302 may be implemented, at least in part, by the control unit 22 and stored in memory associated with the control unit 22 and/or included with or accessible by the vehicle 10.

The implementation module 240 is generally configured to determine, based on signals communicated from the plurality of environmental sensors 18, one or more qualities of the occupant of the vehicle. Based on the determined quality(ies) of the occupant, the implementation module 240 may activate or cause to be activated one or more audio signal supplementation capabilities of the vehicle 10 and/or system 100. Additionally or alternatively, the method 302 may include determining based on signals communicated from the environmental sensors, at least one quality of the occupant of the vehicle. It should be appreciated that the signals communicated from the environmental sensors 18 for determining the quality(ies) of the occupant may include optical data, images, videos, or the like communicated from one or more cameras, optical sensors, LiDAR sensors, radar sensors, proximity sensors, infrared sensors, seat sensor(s), or the like. Additionally or alternatively, sound or audio data communicated from suitable environmental sensors 18 may be utilized to determine the quality(ies) of the occupant. It should be appreciated that the environmental sensors 18 utilized to determine the quality(ies) of the occupant may include one or more external environmental sensors 18A, cabin environmental sensors 18B, or a combination thereof.

In several embodiments, the implementation module 240 may be configured to activate the noise monitoring module 242, the alert module 244, or both based on the determined quality(ies) of the occupant, a determination that an occupant of the vehicle 10 has a hearing impairment, or that a cabin audio environment of the vehicle 10 masks at least one of cabin or external audio signals. For example, the implementation module 240 and/or method may include activating, based on the determined at least one quality of the occupant, at least one audio signal supplementation capability configured to provide audio information via a non-auditory interface of the vehicle, such as dynamic sound tracking. By only activating the noise monitoring module 242, the alert module 244, the audio signal supplementation capability(ies), and/or the dynamic sound tracking capability(ies) described herein when needed, the system 100 may conserve resources (e.g., the vehicle power supply 30 and/or processing power of the system 100 and/or vehicle 10).

The control logic 236 and/or method 302 may additionally or alternatively include receiving data 218A communicated from the external environmental sensor(s) 18A and indicating the audio environmental context of the vicinity surrounding the vehicle 10. The control logic 236 and/or method 302 may additionally or alternatively include receiving data 218 communicated from the cabin environmental sensor(s) 18B and indicating the internal or cabin audio environment of the vehicle 10. For example, internal vehicle environmental data 218B may be communicated from the internal environmental sensor(s) 18B and indicate the internal environment or cabin environment of the vehicle 10. The control logic 236 and/or method 302 may additionally or alternatively include receiving vehicle parameter data 218C communicated from one or more components or systems included in or associated with the vehicle 10 and/or system 100, e.g., engine parameters, geographical location, elevation information, power supply information, or the like. In some embodiments, the implementation module 240 and/or method 302 may be configured to activate one or both of the noise monitoring module 242, the alert module 244, and/or associated elements of method 302 (described in more detail below) in response to an input received via an interface device 32 of the vehicle 10 indicating that supplementing audio signals for an occupant of the vehicle 10 or dynamic sound tracking is desired, such as via an accessible setting.

In some embodiments, an artificial intelligence algorithm (e.g., AI program 230) may be utilized to determine the quality(ies) of the occupant based on signals communicated from the environmental sensors 18, especially the external vehicle environmental data 218A and/or the internal vehicle environmental data 218B. For example, the method 302 may include determining that the occupant has a hearing impairment. As described in more detail below, the position of the source of sound and the at least one quality of the source of sound may be determined in response to the determination that the occupant has the hearing impairment. For example, AI program 230 or one or more other suitable AI programs may be configured to determine that the occupant has a hearing impairment based on external vehicle environment data 218A (such as audio or visual data) communicated from the external environmental sensor(s) 18A, internal vehicle environment data 218B (such as audio or visual data) communicated from the cabin environmental sensor 18B, and/or vehicle parameter data 218C communicated from other system or components of the vehicle 10, e.g., the vehicle power source 28, the vehicle power supply 30, the audio system 34, the electronic vehicle control system, the navigation or global positioning system, or other systems or components utilized in association with operation of the vehicle 10. In one example, the occupant quality (e.g., at least some degree of hearing loss) may be indicated by the presence of a hearing aid as indicated by the environmental data 218.

In an additional or alternative embodiment, the implementation module 240 may be configured to identify a profile associated with the occupant based on the determined quality(ies) of the occupant. The associated profile may generally indicate other qualities of occupant, confirm the determined quality(ies) of the occupant, and/or may indicate one or more audio signal supplementation capabilities such as dynamic sound tracking are desired or required. Additionally or alternatively, the method 302 may include identifying, based on the determined at least one quality of the occupant, a profile associated with the occupant, the profile indicating that the at least one audio signal supplementation capability is desired or required. For example, information indicated from one or more occupant profiles (one occupant profile 234 depicted in FIG. 2 for simplicity) may be stored or accessible by the system 100 and/or vehicle 10. The AI program 230 is generally suitable for and properly trained to determine the quality(ies) or the characteristic(s) of a person or people in the vicinity of and/or in the cabin of the vehicle 10 based on the vehicle environment data 218 and identify the occupant by matching such determined quality(ies) and/or characteristic(s) with indications of the quality(ies) and/or characteristic(s) of the person associated with each profile 234. Particularly, each profile 234 may indicate whether the associated person has a hearing impairment, details with respect to the hearing loss of the associated person, whether the person desires or requires one or more audio signal supplementation capabilities, and/or which audio signal supplementation capabilities are desired.

Additionally or alternatively, the environmental sensors 18 may include a wireless receiver, transceiver, or the like. In some such embodiments, the quality(ies) of the occupant may be determined based at least partially on information received from the wireless receiver/transceiver and communicated from an external device 26 of the operator, such as a transmitter or transceiver of an external device 26, such as a mobile device 20 and/or other remote device 24 (e.g., a key bod, an RFID transmitter, a hearing aid, or the like). For example, many such remote devices 24 may be suitable to and/or configured to transmit information indicating one or more qualities of the associated person (e.g., occupant of the vehicle 10) in response to establishment of communication between the remote device 24 and the vehicle 10 and/or system 100. Additionally or alternatively, certain devices or associated identification information (e.g., IP address, MAC ID, serial number, etc.) may be linked to one or more occupant profiles 234. The control logic 236 and/or method 302 may additionally or alternatively include identifying an occupant profile 234 associated with the previous occupant, operator, or the like of the vehicle 10 and/or the mobile device 20 associated with such occupant. For example, the internal vehicle environmental data 218B during a previous trip of the vehicle 10 may indicate one or more characteristics of the previous occupant of the stowed vehicle 10 and may be utilized to identify (or generate and subsequently identify) the occupant profile 234 and/or mobile device 20 associated with the previous occupant in questions. In several instances, the AI algorithm(s) 230 may be utilized to identify an occupant profile 234 of multiple occupant profiles 234 stored at or accessible by the vehicle 10 and/or system 100 based on the vehicle environment data 218. Alternatively, the occupant profile 234 and/or mobile device 20 may be determined based on the last mobile device 20 communicatively linked with the vehicle 10 and/or system 100.

Some remote devices 24 and/or profiles 234 may also indicate information about the hearing loss of the associated occupant. For example, a hearing aid may be configured to communicate information with respect to its frequency tuning and/or a hearing loss frequency range of the occupant via near field communication with the vehicle 10 or the system 100. It should be appreciated that hearing aids typically to not amplify all frequencies of sound but are rather programmed to amplify sounds that the owner of the hearing aid cannot hear. Such tuning of a hearing aid or similar device is a medical procedure, but the outcome and/or equations (e.g., gain) utilized may be imported by the vehicle 10 and/or system 100 to fine tune the audio signal supplementation capabilities to the needs of the particular occupant. Such information may possibly be communicated with the assistance of another remote device 24, such as a mobile device 20. The remote device(s) 24 may additionally or alternatively include or have access to (such as via the cloud or a suitable mobile application) information about the hearing loss of the associated occupant, which may be communicated automatically or selectively to the vehicle 10 or system 100. Alternatively, the vehicle 10 and/or system 100 may directly retrieve such information from the cloud, via a suitable mobile application, or the like. Such information may additionally or alternatively already be stored in the profile 234 associated with the occupant or may be uploaded to the profile 234 by the occupant.

In additional or alternative embodiments, the method 302 may include determining, based on the signals communicated from the environmental sensors, that a cabin audio environment of the vehicle masks at least one of cabin or external audio signals. Additionally or alternatively, one or more other suitable AI programs may be configured to determine that the cabin audio environment of the vehicle 10 masks cabin or external audio signals (AI program 232) based on external vehicle environment data 218B (such as audio data) communicated from the external environmental sensor(s) 18A, internal vehicle environment data 218B (such as audio data) communicated from the cabin environmental sensor 18B, and/or vehicle parameter data 218C communicated from other system or components of the vehicle 10, e.g., the vehicle power source 28, the vehicle power supply 30, the audio system 34 (e.g. historic or current media sound level), the electronic vehicle control system, the navigation or global positioning system, or other systems or components utilized in association with operation of the vehicle 10.

Furthermore or alternatively, the implementation module 240 may be configured to determine a seat associated with the occupant based at least partially on the vehicle environmental data 218 (optionally via one or more AI programs 230, 232 and/or one or more additional or alternative, suitably configured, AI programs). For example, data indicating the seat via an associated seat sensor, data indicating the door opened or approached to enter the vehicle, seat belt utilization data, or the like may indicate the where the occupant is seated or is about to be seated in the vehicle 10. In some embodiments, at least the operator/driver seat of the vehicle 10 may be identified as associated with the occupant, especially in a situation where the vehicle 10 is determined to have only one occupant.

Thus, it should be appreciated that various aspects of the control logic 236, the method 302, or parts or components thereof may generally be implemented utilizing one or more artificial intelligence algorithms (e.g., AI algorithm(s) 230, 232, 250, 260, or 270) and based on the external vehicle environment data 218A, the internal vehicle environment data 218B, and/or the vehicle parameter data 218C, especially portions of such data indicating optical data, images, videos, sounds, audio signals, and the like. As non-limiting examples, determining the quality(ies) of the occupant, determining the profile 234 associated with the occupant, determining the position of the source of the sound relative to the vehicle 10, determining the one or more qualities of the sound, and generating the appropriate indicator or features thereof, dynamically tracking the source of sound, and/or choosing appropriate video feeds of the source of sound to display to the occupant/operator may utilize one or more suitably trained AI programs, e.g., AI programs 230, 232, 250, 260, and/or 270, respectively.

The AI program(s)/algorithm(s) 230, 232, 250, 260, and/or 270 may include one or more algorithms, programs, modules, and the like suitable to simulate intelligence human behavior or perform tasks historically requiring human implementation. For example, the AI algorithm(s) may include, without limitation, one or more of machine learning algorithms, artificial neural networks, recurrent artificial neural networks, feedforward neural networks, convolutional neural networks, recurrent neural networks, deep neural networks, natural language processing algorithms, long short term memory networks, inductive logic programming algorithms, support vector machines, clustering algorithms, Bayesian networks, reinforcement learning algorithms, representation learning algorithms, similarity and metric learning algorithms, sparse dictionary learning algorithms, genetic algorithms, k-nearest neighbor (KNN) algorithms, decision tree learning algorithms, association rule learning algorithms, and the like. Some of the AI algorithm(s) 230, 232, 250, 260, and/or 270 described herein may be trained (via a supervised or unsupervised training process) based on training data provided to the AI algorithm(s) 230, 232, 250, 260, and/or 270. In one optional configuration, the AI algorithm(s) utilizes a neural network (NN), such as a convolutional neural network (CNN), that is trained to segment and annotate images and/or identify sounds based on experiential learning. The AI algorithm(s) may utilize computer vision (CV), computer hearing (CH), and/or deep learning (DL) algorithms applied to the obtained images and/or sounds to enable both object and scenario detection, as well as wide area condition detection—is the scene urban, rural, a mountain, a seashore, a bridge; is the external environment and/or vicinity of the vehicle wet, slippery, windy, is there an accident, unconscious pedestrian, or an emergency vehicle; etc.?

Such process may further enable both interior and external situational awareness—is the vehicle 10 unoccupied or is the operator simply taking a nap in the vehicle 10; is the vicinity and/or external environment of the vehicle 10 noisy, crowded, a high-foot-traffic area, quiet, a low-foot-traffic area? The present disclosure is agnostic related to these AI methodologies, and any suitable AI methodologies may be utilized equally. It should be appreciated that various embodiments of the method 302 and/or disclosed system 100 are primarily directed to supplementing audio signals for occupants of vehicles and/or the implementation of dynamic audio tracking capabilities for vehicles.

Referring still to FIGS. 2 and 3, the control logic 236 may include the noise monitoring module/method 242 configured to determine, based on signals 218 communicated from the environmental sensors 18, a position of the source of the sound relative to the vehicle 10, at least one quality of the sound, or both. In various embodiments, the control logic 236 and/or the noise monitoring module may be configured to identify that the source of sound is within the vicinity of the vehicle 10 based on signals communicated 218 from one or more of the environmental sensors 18, see also method element 304. For example, sound intensities and/or frequencies within the human-audible range at the vehicle 10 may be associated with sources of sound within the vicinity of the vehicle 10 regardless of distance. However, the vicinity may be restricted to be within a predetermined range or based on the determined environmental context surrounding the vehicle 10, as described above.

Additionally or alternatively, the method 302 may include determining, based on signals communicated from the plurality of environmental sensors, a current position of a source of a sound relative to the vehicle and/or at least one quality of the sound, see, e.g., method element 306. In various embodiments, identifying that the source of sound is within the vicinity of the vehicle 10 may be based on environmental data 218 communicated from one or more initial environmental data. Thereafter, additional environmental data 218 communicated from one or more additional environmental sensors 218 may utilized to determine the current position of the associated source of sound. For example, an omnidirectional microphone, a microphone oriented in a different direction, a microphone oriented in the direction of the source of sound, or the like may communicate signals 218 sufficient to determine that the source sound is within the vicinity of the vehicle. Thereafter, environmental data 218 communicated from at least one different environmental sensors (e.g., a camera oriented toward the source of sound, a microphone oriented toward the source of sound, or the like) may be utilized to determine the current position of the source of sound. It should be appreciated that such additional environmental sensor(s) 18 may be powered, activated, or properly oriented in order to capture environmental data 218A sufficient to determine the current position of the source of sound in response to a determination that the currently available environmental data 218A is insufficient for such determination.

It should be appreciated that the quality(ies) of the sound may indicate a type of event or source generating or likely generating the sounds, and/or may be sufficient for a suitably trained AI program(s) 250 and/or 260 to determine the same. The possible qualities of the sound may include, but is not limited to, an intensity of the sound, a defective tire of the vehicle 10, a siren of another vehicle, a horn of another vehicle, an impact of the vehicle 10, a vehicular collision within a vicinity of the vehicle 10, a faulty brake or associated components of the vehicle, or a malfunction of the vehicle or an associated component. It should be appreciated that certain mechanical failures may be identified or indicated by the type of sound or frequencies of sound generated. As explained in more detail below, one or more indicators may be associated with each of these potential qualities of the sound and/or associated types of sound sources.

Additionally or alternatively, the method 302 may include determining based on signals communicated from the plurality of environmental sensors and in response to the determination that the occupant has the hearing impairment, a position of a source of a sound relative to the vehicle and/or at least one quality of the sound. Additionally or alternatively, the method 302 may include determining based on signals communicated from the plurality of environmental sensors and in response to the determination that the cabin audio environment of the vehicle masks at least one of cabin or external audio signals, a position of a source of a sound relative to the vehicle and/or at least one quality of the sound.

It should be appreciated that the external environment and/or cabin of the vehicle 10 may include numerous sounds or noises. Furthermore, indicating each present sound or noise may not be feasible or even desirable, as providing an operator of the vehicle 10 with too much information may confuse the operator and/or cause the operator to ignore the indicators provided via the non-auditory interface 32 of the vehicle 10. In several embodiments, the control logic 236 and/or noise monitoring module 242 may be configured to select the sound for audio supplementation and/or dynamic tracking from multiple or numerous sounds in the vicinity of the vehicle 10 based on the environmental data 218 communicated from the environmental sensors 18, see also method element 308. For example, the sound selected for generation of the indicator may be based at least on an importance of an event associated with generation of the sound and/or a current driving condition of the vehicle. It should be appreciated that the AI program(s) of the noise monitoring module (e.g., AI program(s) 250, 260, and/or other suitably configured AI programs) may be configured to select the sound for audio signal supplementation based on the determined quality(ies) of the occupant, the determined quality(ies) of the sound, and/or the environmental data 218 indicating the possible sounds to select. In some such embodiments, the sound may be selected based on an importance of an event associated with generation of the sound or the source of sound. The importance of the sound and/or source of sound may be based, at least in part, on the environmental data 218 and/or a determination of the quality(ies) or characteristics of the sound or source of sound, as described above. For example, the AI program(s) 250 and/or 260 may determine the importance of the event associated with the generation of the sound based on the vehicle environment data, especially the audio data thereof. It should be appreciated that non-audio data (e.g., optical data and/or vehicle parameter data 218C) may additionally or alternatively be utilized to determine the importance of the event associated with the generation of the sound and/or the current driving condition of the vehicle 10. For example, a determination of flashing lights based on optical data may confirm a determination of a siren based on audio data and vice versa and/or a combination of such data be utilized to confirm or to update the location of the source of one or both of the flashing lights and siren.

As a non-limiting example, a siren of an emergency vehicle may be selected over the honking of another vehicle's horn, which may be selected over the engine noise of a motorcycle, which may be selected over engine revving noises of an adjacent, standard vehicle (e.g., a vehicle other than a motorcycle, autocycle, or other vehicle without the occupant protection associated with a standard vehicle such as a roof, seat belt, airbag, etc. or more difficult to see than a standard vehicle). Thus, it should be appreciated that some vehicles make loud noises as a safety feature, and embodiments of the present system 100, control logic 236, and/or method 302 may be suitable to provide audio supplementation and/or dynamic audio tracking for such vehicles prioritized over other, less important sounds.

Additionally or alternatively, the sound may be selected based on the determined quality(ies) of the occupant. Thus, some embodiments of the method 302 include selecting the sound and/or sound source for audio supplementation and/or dynamic tracking based on the determined at least one quality of the occupant. For example, the quality(ies) of the occupant may include a hearing loss frequency range (e.g., as indicated by the tuning of a hearing aid or data of a hearing test). In such a situation, the selected sound may include sound waves within the hearing loss frequency range of the occupant. In an additional or alternative example, the quality(ies) of the occupant may include a determination or information indicating that the occupant has more severe hearing loss in one of a right ear or a left ear. In such a situation, the sound selected for audio signal supplementation and/or dynamic audio tracking may include a sound source positioned closer to the ear with more severe hearing loss. By selecting sounds for audio signal supplementation and/or dynamic audio tracking based on the needs of the occupant, the system 100 may conserve resources (e.g., the vehicle power supply 30 and/or processing power of the system 100 and/or vehicle 10) and/or may avoid providing the occupant with excessive, unnecessary information that may be more distracting than helpful.

In some embodiments, the vehicle environment data 218 includes external vehicle audio data 218A and internal vehicle audio data 218B. In some such embodiments, the control logic 236 and/or noise monitoring module 242 may be configured to determine the position of the source of the sound as either within the cabin of the vehicle 10 or the external environment of the vehicle 10. For example, the method 302 may include determining, based on signals communicated from both the cabin environmental sensor and the external environmental sensor, the position of the source of the sound as either within the cabin of the vehicle or the external environment (e.g., vicinity) of the vehicle 10. It should be appreciated that the external/cabin location determination may also be indicative of the quality of the sound and/or the type of event generating the sound. For example, determining that the position of the source of the sound is external and over a predetermined threshold distance from the vehicle 10 may be utilized to determine qualities of the sound, a source of the sound, and/or a type of sound that cannot be local to the vehicle 10. Thus, the current system 100 may determine that the sound is not associated with defective vehicle tires of the vehicle 10, faulty brakes of the vehicle 10 (e.g., old screeching brake pads, calipers, or the like), impacts on or involving the vehicle 10, or other malfunction, worn, or damaged components of the vehicle 10 itself.

Referring still to FIGS. 2 and 3, the control logic 236 may include the alert module/method 244 configured to provide audio information via a non-auditory interface 32 in response to activation of the one or more audio signal supplementation capabilities, such as dynamic tracking of sounds in the vicinity of the vehicle 10. In various embodiments, the control logic 236 and/or alert module 244 may be configured to indicate via at least one non-auditory interface 26 of the vehicle 10 the current position of the source of the sound relative to the vehicle 10, see also method element 310. Additionally or alternatively, the control logic 236 alert module 244, and/or method 302 may be configured to generate an indicator via a non-auditory interface 32 of the vehicle 10 and based on the determined current position of the source of the sound and/or the one or more determined qualities of the sound.

The indicator generally indicates the determined current position of the sound source relative to the vehicle, the determined one or more qualities of the sound (such as the type of sound or importance of the sound), or both. Additionally or alternatively, the method 302 may include generating, based on the determined relative position of the source of the sound and the at least one quality of the sound, an indicator via a non-auditory interface of the vehicle, the indicator indicating at least one of the determined position of the sound source relative to the vehicle or the determined at least one quality of the sound. In some embodiments, the indicator may indicate both the determined current position of the sound source relative to the vehicle 10 and the determined quality(ies) of the sound. The non-auditory interface 32 may include one or more of a haptic feedback device on a steering wheel of the vehicle 10, an infotainment display of the vehicle 10, an instrument panel of the vehicle 10, a heads-up display of the vehicle 10, another display or touchscreen of the vehicle 10, or the like.

The alert module 244 may additionally or alternatively be configured to select the non-auditory interface 32 or multiple non-audio interfaces for providing audio information and/or dynamic sound tracking based on the determined seat associated with the occupant For example, the determination by the system 100 and/or implementation module 240 of the seat associated with the occupant, as described above, may be utilized to select the non-auditory interface(s) 32 utilized to provide the audio information. Thus, the system 100 may conserve resources (e.g., the vehicle power supply 30 and/or processing power of the system 100 and/or vehicle 10) and provide information to the occupant via the most suitable single or combination of non-auditory interfaces 32.

In embodiments where the non-auditory interface 32 includes the haptic feedback devices of the steering wheel, the steering wheel may include multiple imbedded or coupled haptic feedback devices arranged on the steering wheel allowing the determined position of the sound source to be indicated. For example, two or more haptic feedback devices may be included with the steering wheel and capable of indicating that the determined source of sound is positioned one or more of on the driver side of the vehicle 10, on the passenger side of the vehicle 10, forward of the vehicle 10, aft of the vehicle 10, or colinear with the vehicle 10 via activation of the appropriate haptic feedback device or combination of haptic feedback devices. Furthermore, the intensity of the output of the haptic feedback device(s) may indicate, for example, a sound intensity of the sound, a distance of the sound source from the vehicle, and/or an importance of the event associated with production of the sound or the sound source.

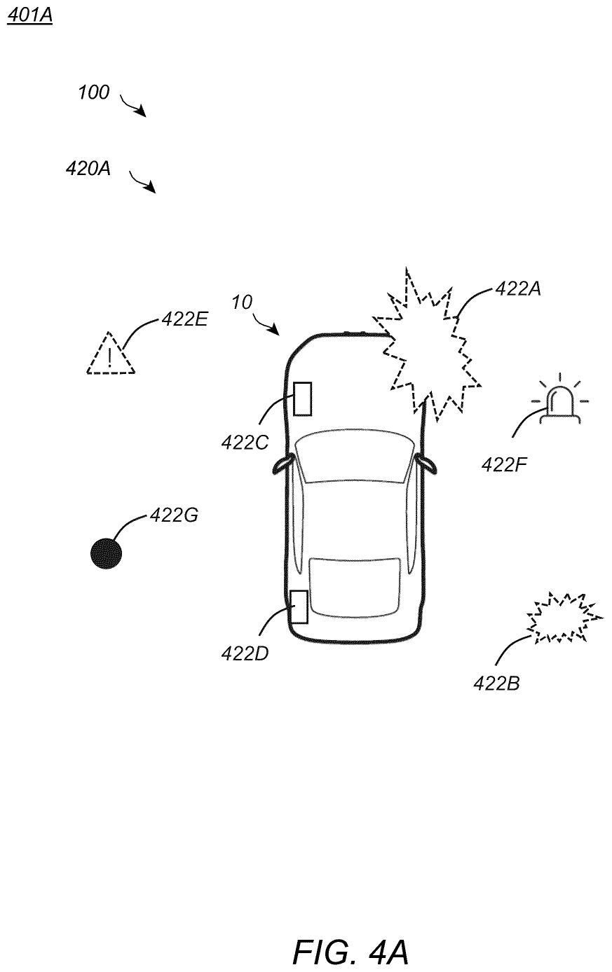

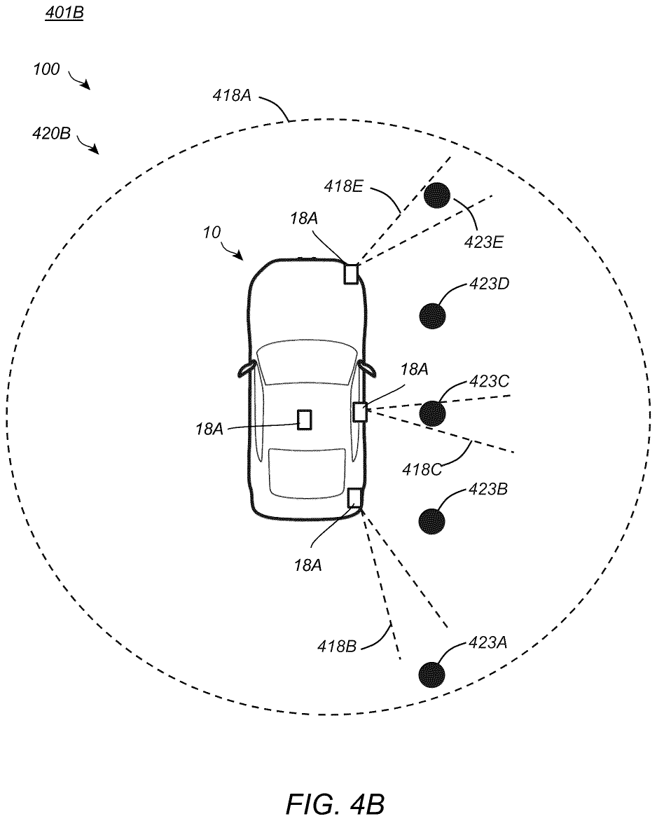

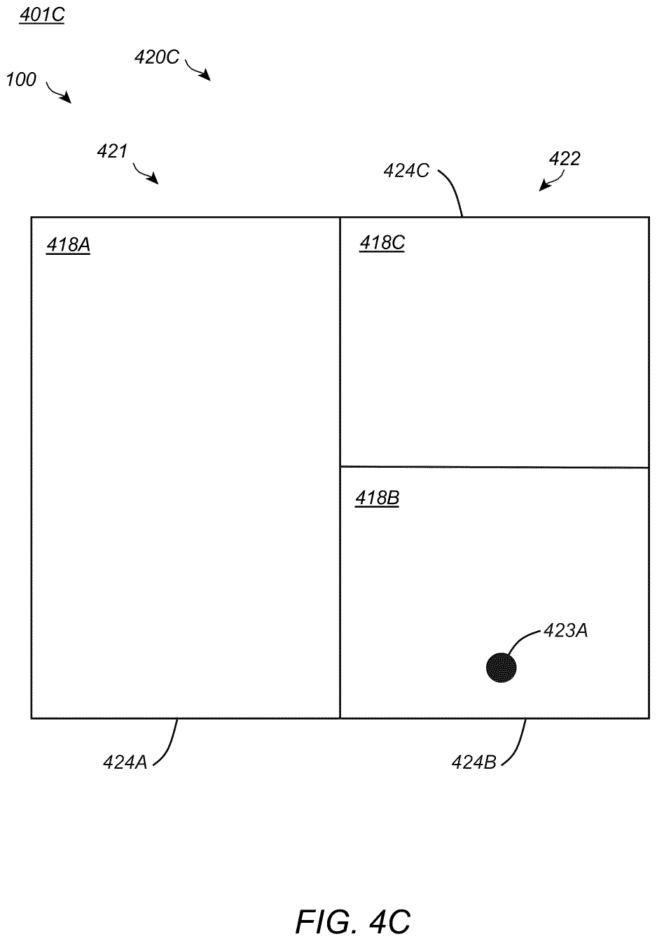

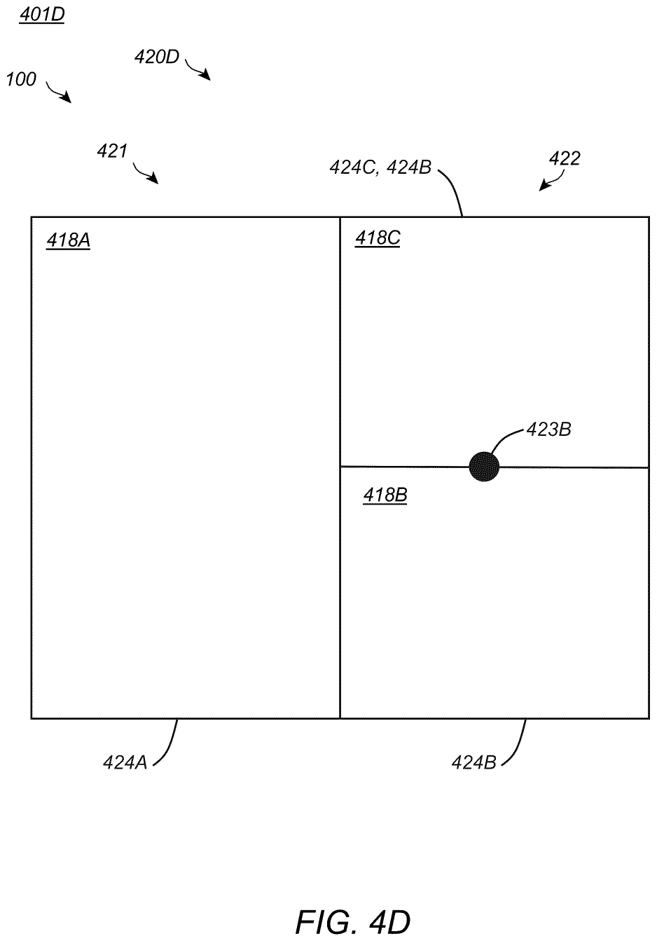

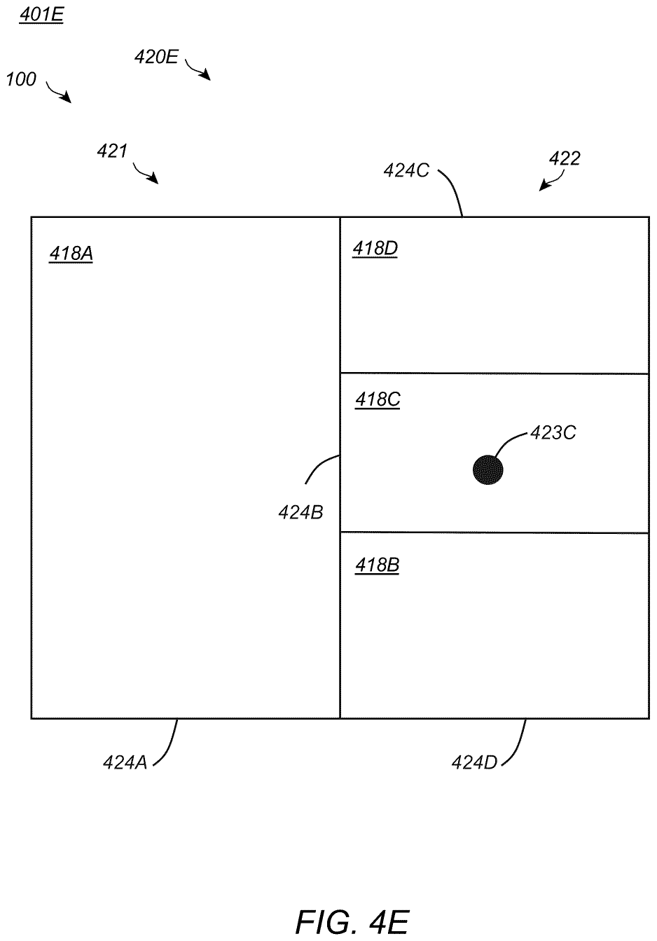

Referring now to FIG. 4A, a schematic drawing of an exemplary display is illustrated depicting indicators and that may be produced by any of the visual and non-auditory interfaces described herein and in accordance with aspects of the present subject matter. As shown, the display 420A may include a representation of the vehicle 10 and one or more representations of indicators 422 that represent the determined current position of associated sources of sound, as determined by the system 100 and described herein. The indicators may also indicate the determined quality(ies) of the sound via selection of different symbols for the indicators 422. As non-limiting examples and as shown, a first symbol 422A may indicate an impact or collision involving the vehicle 10, a second symbol 422B may indicate a collision involving another vehicle in the vicinity of the vehicle 10, a third symbol 422C may indicate a defect involving an associated tire (blown out tire, a tire rubbing other components of the vehicle 10, etc.) of the vehicle 10, a fourth symbol 422D may indicate a worn or faulty associated brake of the vehicle 10, a fifth symbol 422E may indicate an issue with another vehicle in the vicinity of the vehicle 10 that the system 100 or associated AI programs have determined are important to operation of the vehicle 10 in question (e.g., a tire blow out of an adjacent vehicle 10, the horn of an adjacent vehicle 10, or the like), a sixth symbol 422F may indicate another vehicle operating a siren in the vicinity of the vehicle 10, and a seventh symbol 422G may indicate an intensity of a loud noise and/or the determined current position of the source when the cause of the sound has yet to be determined. It should be appreciated that additional or alternative symbols or features of the symbols may indicate other qualities of the sound determined by the system 100, and as described herein. For example, the color, size, thickness, pulsating images, or the like may indicate sound intensity, importance of the cause of the sound, closeness to the vehicle 10, or other information useful for operation of the vehicle 10.

Referring now to FIGS. 2-4, the alert module 244 may additionally or alternatively operate to generate an additional indicator via the same or a different non-auditory interface 32 of the vehicle 10 based on the determined relative current position of the source of the sound and at least one quality of the sound. The additional indicator indicates at least one of the determined current position of the sound source relative to the vehicle 10 or the determined quality(ies) of the sound. Additionally or alternatively, the method 302 may include generating, based on the determined relative current position of the source of the sound and at least one quality of the sound, an additional indicator via a different non-auditory interface of the vehicle, the additional indicator indicating at least one of the determined current position of the sound source relative to the vehicle or the determined at least one quality of the sound. The additional indicator generally indicates additional information relative to the indicator 422. For example, the additional indicator may be a second or subsequent of the indicators 422 illustrated in FIG. 4A. Additionally or alternatively, the original indicator may be haptic feedback of the steering wheel indicating, for example, the determined current position of the sound source and/or intensity of the sound. The additional indicator may be a display indicator 422 of FIG. 4 indicating determined information identifying a more exact current position and/or the source of the sound (e.g., the cause or likely cause).

Referring now to FIG. 4B, a schematic drawing of an exemplary additional or alternative display is illustrated depicting an indicator and that may be produced by any of the visual and non-auditory interface described herein and in accordance with aspects of the present subject matter. As shown, the display 420B may generally be configured similar to display 420A and include the representation of the vehicle 10. However, display 420B may generally be configured to provide dynamic tracking of a source of sound via an indicator 423. It should be appreciated that indicator 423 may be any of the indicators 422 described with respect to FIG. 4A, a similar indictor, or another indicator providing information with respect to at least one determined characteristic or quality of the sound or source of sound, as described herein. In various embodiments, the source of sound associated with indicator 423B may be an emergency vehicle with a siren, a vehicle that has utilized or is utilizing a horn, a motorcycle, an autocycle, or the like. While one indicator 423 is shown in FIG. 4B illustrating different positions of the source of sound for different times (e.g., 423A, 423B, 423C, 423D, 423D), multiple indicators 423 may be displayed indicating multiple sources of sound. Additionally or alternatively, one or more important sounds may be selected for generation of the indicator(s) 423 based on the importance of the source of sound or event associated with the source of sound, as described herein. For example, an indicator 423 associated with an ambulance may be selected for representation in the display 420B over a less important sound, such as a loud muscle car or hot rod.

Indicating the current position of the source of sound relative to the vehicle 10 utilizing the non-auditory interface(s) 26 (e.g., method element 310) may include generating indicator 423A indicating the determined current position of the associated sound source relative to the vehicle 10. Generally, the dynamic display 420B may be configured to indicate a sensed or predicted change in the position of the source of sound associated with indicator 423, such as in real-time, contemporaneously, instantaneously, nearly instantaneously, or the like. Thus and in several embodiments, the vehicle 10, system 100, control unit 22, control logic 236, noise monitoring module 242, and/or any associated AI programs may be configured to determine an updated position of the source of sound (e.g. position associated with any indicator 423B-423E) relative to the vehicle 10 based on a predicted change in the position of the sound source (e.g., associated with indicator(s) 423B or 423D), a sensed change in the position of the source of sound (e.g., associated with indicator(s) 423C, 423D), or both. Additionally or alternatively, the method 302 may include determining an updated position of the source of sound relative to the vehicle based on at least one of a predicted change in the position of the sound source or a sensed change in the position of the source of sound (method element 312).

In several embodiments, a predicted updated position of the sound source may be based on the determined current position of the source of sound and a determined previous position of the source of sound. For example, the subsequently generated indicator 423D may be generated based on the determined position associated with indicator 423C and a previously determined position associated with indicator 423A. A suitable AI program (e.g., 250 or 260) may be trained to generate the predicted updated position of the source of sound based on the trajectory/velocity information indicated by the current and past positions of the source of sound and possibly the environmental data 218, such as external environmental data 218A (e.g., data indicator 418A, 418B, 418C, and/or 418E communicated from one or more suitable environmental sensors 18A, as described herein). Additionally or alternatively, the method 302 may include generating the predicted updated position of the sound source based at least in part on the determined current position of the source of sound and a determined previous position of the source of sound, and wherein the indicator is updated based, at least in part, on the predicted updated position of the sound source (method element 314). Additionally or alternatively, a sensed updated position of the sound source may be based on subsequent signals (218) communicated from the environmental sensor(s) 18. For example, subsequently generated indicator 423C may be generated based on a sensed updated position of the source of sound indicated by the environmental data 418C communicated from one or more suitable environmental sensors 18A as the source of sound moves within the applicable sensible area of the environmental sensor(s) 18A. Additionally or alternatively, the method 302 may include generating the sensed updated position of the sound source based at least in part on subsequent signals communicated from the plurality of environmental sensors (method element 316).

It should also be appreciated that the updated position of any such sources of sound may be based on both predicted changes of position of the source of sound and sensed changes in the position of source of sound. For example, a bird's-eye-view camera 18A may provide information (e.g., data 418A) indicating changes in the position of the source of sound but without enough detail to determine an updated position of the source, and the predicted change in the position of the sound source may be further based on such data (e.g., as determined by AI program(s) 250, 260.

In several embodiments, the vehicle 10, system 100, control unit 22, control logic 236, noise monitoring module 242, the alert module 244 and/or any associated AI programs may be configured to indicate via the non-auditory interface(s) 32 of the vehicle 10 the updated position of the source of relative to the vehicle 10. Additionally or alternatively, the method 302 may include indicating via the at least one non-auditory interface of the vehicle the updated position of the source of sound relative to the vehicle (method element 318). For example, any of the indicators 423B-423E indicating an updated position of the associated source of sound based on sensed and/or predicted changes in the position of the source of sound may generated within the dynamic display 420B. In some embodiments, the currently displayed and/or generated indicator 423 may be updated to indicate the updated position of the source of sound based on sensed and/or predicted changes in the position of the source of sound or changes in the determined quality(ies) and/or characteristics of the source of sound, as described herein. Thus and in some embodiments, previous indicators 423 may be removed once a subsequent indicator 423 is generated. However, one or more past indicators 423 may be retained to indicate the trajectory of the source of sound and/or changes in the characteristics/qualities of the sound, at least in some embodiments.

Referring now to FIGS. 4C-4E, schematic drawings of exemplary additional or alternative displays are illustrated indicating the current and updated positions of the source of sound relative to the vehicle utilizing video feeds and in accordance with aspects of the present subject matter. It should be appreciated that the depicted displays 420C, 420D, and/or 420E may be provided by one or more of the non-auditory interfaces 26 described herein. Generally, any of the displays 420C, 420D, and/or 420E may include a first media element 421 and a second media element 422. The first and second media elements 421, 422 may be produced in different portions of a same display, screen, touch screen, heads-up display, instrument panel, or the like of the same non-auditory interface 32. Additionally or alternatively, first media element 421 may be provided via a first non-auditory interface 32 or screen and second media element 422 may be provided via a second, different non-auditory interface 26 or screen. It should be appreciated that any or multiple of displays 420C, 420D, 420E, first media element 421, and second media element 422 may be provided additionally or alternatively to any of the other indicators described herein, including haptic feedback, display 420A, display 420B, or the like.

As shown in FIGS. 4C-4D, the vehicle 10, system 100, control unit 22, control logic 236, noise monitoring module 242, the alert module 244, and/or any associated AI programs may be configured to display via a first media element 421 and the non-auditory interface(s) 26 one or more video feeds (e.g., 418A) of the vicinity of the vehicle 10 (e.g., media subelement 424A). Additionally or alternatively, the method 302 may include displaying via a first media element and the at least one non-auditory interface at least one video feed of the vicinity of the vehicle (method element 320). The video feed(s) 418A of the vicinity of the vehicle 10 may be generated utilizing a bird's-eye-view camera, an assembly of images/videos provided by different cameras of the vehicle 10, or the like. In some embodiments and as shown, indicating the current position of the source of sound relative to the vehicle via the non-auditory interface(s) 26 (e.g., method element 310), may include displaying via the second media element 422 one or more submedia elements 424B including one or more video feeds indicating the current position of the source of sound relative to the vehicle 10 in more detail than the video feed(s) (e.g., 418A) of the subelement 424A (e.g., indicator 423A of video feed 418B of FIG. 4C, indicator 423B of video feed 418B and/or video feed 418C FIG. 4D, and/or indicator 423C of video feed 418C of FIG. 4E). Additionally or alternatively, the method 302 may include displaying via a second media element and the at least one non-auditory interface at least one video feed indicating the current position of the source of sound relative to the vehicle in more detail than the at least one video feed of the vicinity of the vehicle (see method element 322).

In some embodiments, indicating the updated position of the source of sound relative to the vehicle (e.g., method element 318) may include displaying via the second media element 422 one or more submedia elements 418C including one or more additional video feeds indicating the updated position of the source of sound (e.g., sensed and/or predicted) relative to the vehicle 10 in more detail than the video feed(s) (e.g., 418A) of the subelement 424A (e.g., video feed 418C of FIG. 4C, indicator 423B and/or video feed 418C of FIG. 4D, and/or video feed 418D of FIG. 4E). Additionally or alternatively, the method 302 may include displaying via the second media element and the at least one non-auditory interface an additional video feed indicating the updated position of the sound source relative to the vehicle in more detail than the at least one video feed of the vicinity of the vehicle (method element 324). In some embodiments and as shown in FIG. 4C, the additional video feed (e.g., 418C) provided in subelement 424C may selected based on a predicted updated location of the associated sound source, but the sound source has yet to move into the sensible area of the associated camara providing such video feed, see also video feed 418D of FIG. 4E. Furthermore or alternatively and as shown in FIG. 4D, the additional video feed (e.g., 418C) provided in subelement 424B, 424C may selected based on a determination that the associated video feed partially indicates the sensed updated position of the source of sound, the predicted updated position of the source of sound, or both. Such a video feed may be considered as indicating both the current position of source of sound and the predicted updated position of the source of sound relative to the vehicle 10. Furthermore and as shown, an additional or alternative subelement 424B may be displayed in response to a determination that another video feed (e.g., 418B) also at least partially indicates the sensed updated position of the source of sound.

Referring now particularly to FIG. 4E, display 420E illustrates the dynamic and/or real-time aspect of such display. Generally, the indicator(s) 423, media elements 421, subelements thereof 424A, 424B, 424C, and/or video feeds thereof may be updated contemporaneously and/or in real time based on the changing position of the source of sound, especially sensed changes in the position of the source of sound relative to the vehicle 10. Thus and in several embodiments, the vehicle 10, system 100, control unit 22, control logic 236, noise monitoring module 242, the alert module 244, and/or any associated AI programs may be configured to determine a further updated position of the source of sound relative to the vehicle 10 based on sensed or predicted further changes in the position of the source of sound relative to the vehicle 10. Generally, the further updated position of the source of sound relative to the vehicle may be determined subsequent to determining the initial updated position of the source of sound based on the sensed initial change in position of the source of sound. Additionally or alternatively, the method 302 may include determining, subsequent to determining the updated position of the source of sound based on the sensed change in the position of the source of sound, a further updated position of the source of sound relative to the vehicle based on at least one of a further predicted change in the position of the sound source or a further sensed change in the position of the source of sound (method element 326).

Furthermore or alternatively, the vehicle 10, system 100, control unit 22, control logic 236, the noise monitoring module 242, the alert module 244, and/or any associated AI programs may be configured to replace the additional video feed(s) of the second media element 422 indicating the previously determined updated position of the source of sound relative to the vehicle 10 (e.g., video feed 418C of subelement 424C of FIG. 4C) with subelement 424C of FIG. 4E including one or more video feeds (e.g., video feed 418D) indicating the further updated position of the source sound relative to the vehicle 10 in more detail than the video feed(s) (e.g., video feed(s) 418A) of the vicinity of the vehicle 10. Additionally or alternatively, the method 302 may include replacing the additional video feed of the second media element indicating the previously determined updated position of the sound source relative to the vehicle with a further video feed indicating the further updated position of the sound source relative to the vehicle in more detail than the at least one video feed of the vicinity of the vehicle (method element 328).

Furthermore or alternatively, the vehicle 10, system 100, control unit 22, control logic 236, the noise monitoring module 242, the alert module 244, and/or any associated AI programs may be configured to replace the video feed(s) of the second media element 422 indicating the previously determined current position of the source of sound relative to the vehicle 10 (e.g., video feed 418B of subelement 424B of FIG. 4C) with subelement 424B of FIG. 4E including one or more video feeds (e.g., video feed 418C) indicating the previously determined updated position of the sound source relative to the vehicle 10. Additionally or alternatively, the method 302 may include replacing the at least one video feed of the second media element indicating the previously determined current position of the source of sound relative to the vehicle with the additional video feed indicating the previously determined updated position of the sound source relative to the vehicle (method element 330).

Furthermore or alternatively, the vehicle 10, system 100, control unit 22, control logic 236, the noise monitoring module 242, the alert module 244, and/or any associated AI programs may be configured to display via the second media 422 and the non-auditory interface(s) 26 one or more submedia elements 424D including one or more video feeds (e.g., video feed 418B) indicating the previously determined position of the source of sound relative to the vehicle 10, especially in more detail than the video feed(s) (e.g., 418A) of the subelement 424A. Additionally or alternatively, the method 302 may include displaying via the second media element and the at least one non-auditory interface the at least one video feed indicating the previously determined current position of the source of sound relative to the vehicle (method element 332) and/or in more detail than the at least one video feed of the vicinity of the vehicle (method element 334). Thus and in several embodiments, the initially determined current position of the sound source becomes the previously determined position of the sound source once the sensed updated position of the sound source (e.g., the new current position of the sound source) is confirmed by the environmental data 218. Thereafter, a new updated position of the source of sound may verified via the environmental data 218, and the process may be repeated.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

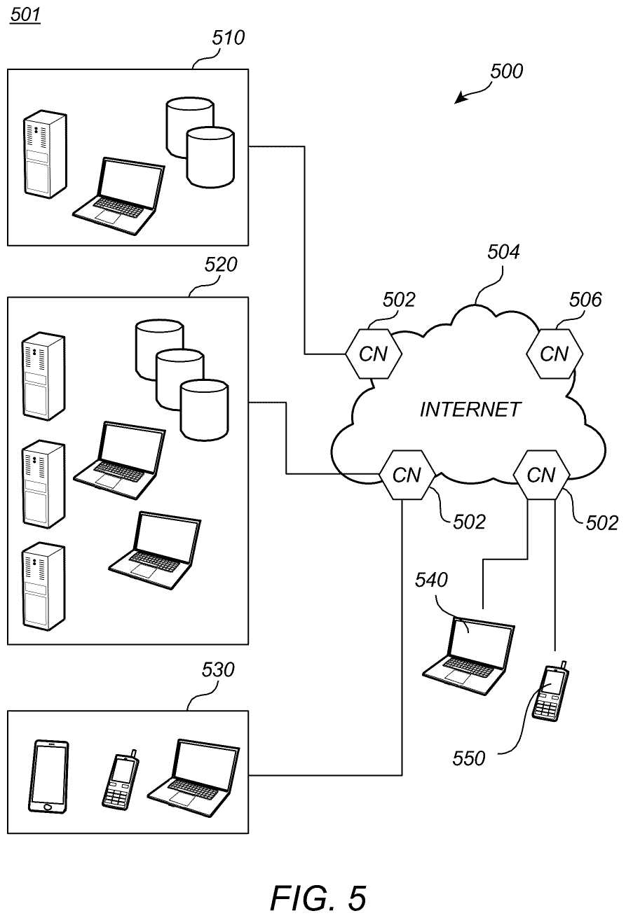

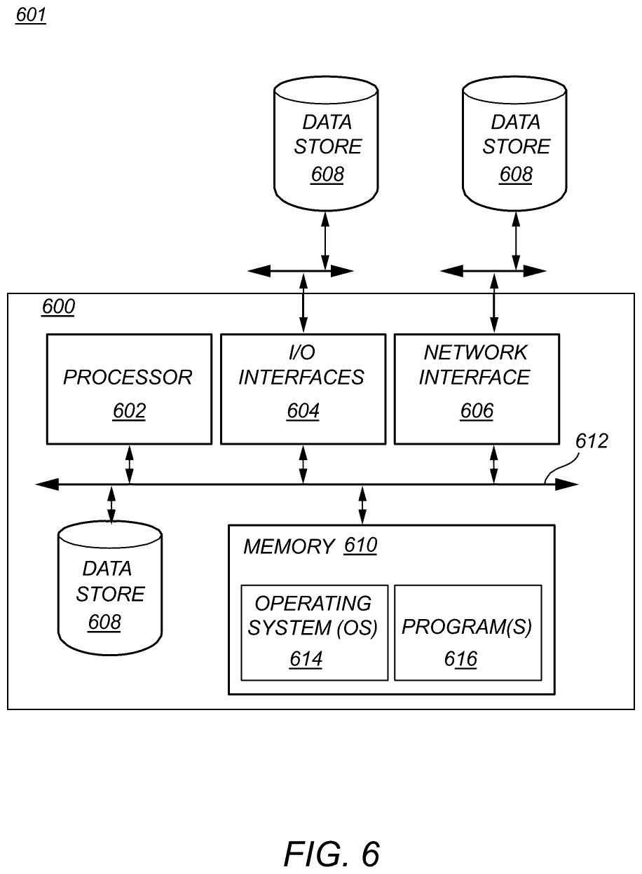

FIG. 5 is a network diagram of a cloud-based system 500 for implementing various cloud-based services of the present disclosure. The cloud-based system 500 includes one or more cloud nodes (CNs) 502 communicatively coupled to the Internet 504 or the like. The cloud nodes 502 may be implemented as a server 600 (as illustrated in FIG. 6) or the like and can be geographically diverse from one another, such as located at various data centers around the country or globe. Further, the cloud-based system 500 can include one or more central authority (CA) nodes 506, which similarly can be implemented as the server 600 and be connected to the CNs 502. For illustration purposes, the cloud-based system 500 can connect to a regional office 510, headquarters 520, various employee's homes 530, laptops/desktops 540, and mobile devices 550, each of which can be communicatively coupled to one of the CNs 502. These locations 510, 520, and 530, and devices 540 and 550 are shown for illustrative purposes, and those skilled in the art will recognize there are various access scenarios to the cloud-based system 500, all of which are contemplated herein. The devices 540 and 550 can be so-called road warriors, i.e., users off-site, on-the-road, etc. The cloud-based system 500 can be a private cloud, a public cloud, a combination of a private cloud and a public cloud (hybrid cloud), or the like.

Again, the cloud-based system 500 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 510, 520, and 530 and devices 540 and 550. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 500 is replacing the conventional deployment model. The cloud-based system 500 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 500 is illustrated herein as one example embodiment of a cloud-based system, and those of ordinary skill in the art will recognize the systems and methods described herein are not necessarily limited thereby.

FIG. 6 is a block diagram of a server 600, which may be used in the cloud-based system 500 (FIG. 5), in other systems, or stand-alone. For example, the CNs 502 (FIG. 5) and the central authority nodes 506 (FIG. 5) may be formed as one or more of the servers 600. The server 600 may be a digital computer that, in terms of hardware architecture, generally includes a processor 602, input/output (I/O) interfaces 604, a network interface 606, a data store 608, and memory 610. It should be appreciated by those of ordinary skill in the art that FIG. 6 depicts the server 600 in an oversimplified manner, and a practical embodiment may include additional components and suitably configured processing logic to support known or conventional operating features that are not described in detail herein. The components (602, 604, 606, 608, and 610) are communicatively coupled via a local interface 612. The local interface 612 may be, for example, but is not limited to, one or more buses or other wired or wireless connections, as is known in the art. The local interface 612 may have additional elements, which are omitted for simplicity, such as controllers, buffers (caches), drivers, repeaters, and receivers, among many others, to enable communications. Further, the local interface 612 may include address, control, and/or data connections to enable appropriate communications among the aforementioned components.

The processor 602 is a hardware device for executing software instructions. The processor 602 may be any custom made or commercially available processor, a central processing unit (CPU), an auxiliary processor among several processors associated with the server 600, a semiconductor-based microprocessor (in the form of a microchip or chipset), or generally any device for executing software instructions. When the server 600 is in operation, the processor 602 is configured to execute software stored within the memory 610, to communicate data to and from the memory 610, and to generally control operations of the server 600 pursuant to the software instructions. The I/O interfaces 604 may be used to receive user input from and/or for providing system output to one or more devices or components.

The network interface 606 may be used to enable the server 600 to communicate on a network, such as the Internet 504 (FIG. 5). The network interface 606 may include, for example, an Ethernet card or adapter (e.g., 10BaseT, Fast Ethernet, Gigabit Ethernet, or 10GbE) or a Wireless Local Area Network (WLAN) card or adapter (e.g., 802.11a/b/g/n/ac). The network interface 606 may include address, control, and/or data connections to enable appropriate communications on the network. A data store 608 may be used to store data. The data store 608 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media. In one example, the data store 608 may be located internal to the server 600, such as, for example, an internal hard drive connected to the local interface 612 in the server 600. Additionally, in another embodiment, the data store 608 may be located external to the server 600 such as, for example, an external hard drive connected to the I/O interfaces 604 (e.g., a SCSI or USB connection). In a further embodiment, the data store 608 may be connected to the server 600 through a network, such as, for example, a network-attached file server.

The memory 610 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 510 may incorporate electronic, magnetic, optical, and/or other types of storage media. Note that the memory 610 may have a distributed architecture, where various components are situated remotely from one another but can be accessed by the processor 602. The software in memory 610 may include one or more software programs, each of which includes an ordered listing of executable instructions for implementing logical functions. The software in the memory 610 includes a suitable operating system (O/S) 614 and one or more programs 616. The operating system 614 essentially controls the execution of other computer programs, such as the one or more programs 616, and provides scheduling, input-output control, file and data management, memory management, and communication control and related services. The one or more programs 616 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

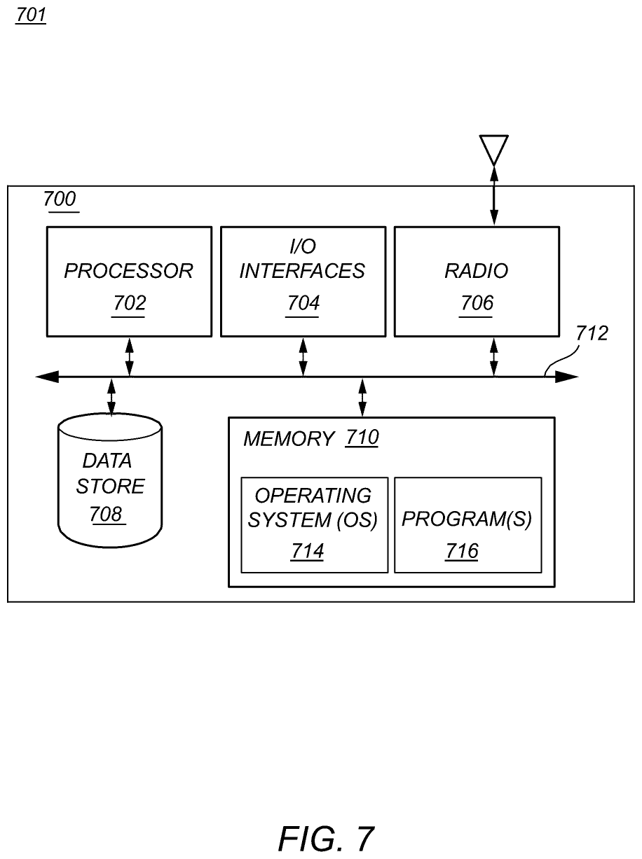

FIG. 7 is a block diagram of a user device 700, which may be used in the cloud-based system 500 (FIG. 5), as part of a network, or stand-alone. Again, the user device 700 can be a vehicle (e.g., one or more control units thereof), a smartphone, a tablet, a smartwatch, an Internet of Things (IoT) device, a laptop, a virtual reality (VR) headset, etc. The user device 700 can be a digital device that, in terms of hardware architecture, generally includes a processor 702, I/O interfaces 704, a radio 706, a data store 708, and memory 710. It should be appreciated by those of ordinary skill in the art that FIG. 7 depicts the user device 700 in an oversimplified manner, and a practical embodiment may include additional components and suitably configured processing logic to support known or conventional operating features that are not described in detail herein. The components (702, 704, 706, 708, and 710) are communicatively coupled via a local interface 712. The local interface 712 can be, for example, but is not limited to, one or more buses or other wired or wireless connections, as is known in the art. The local interface 712 can have additional elements, which are omitted for simplicity, such as controllers, buffers (caches), drivers, repeaters, and receivers, among many others, to enable communications. Further, the local interface 712 may include address, control, and/or data connections to enable appropriate communications among the aforementioned components.

The processor 702 is a hardware device for executing software instructions. The processor 702 can be any custom made or commercially available processor, a CPU, an auxiliary processor among several processors associated with the user device 700, a semiconductor-based microprocessor (in the form of a microchip or chipset), or generally any device for executing software instructions. When the user device 700 is in operation, the processor 702 is configured to execute software stored within the memory 710, to communicate data to and from the memory 710, and to generally control operations of the user device 700 pursuant to the software instructions. In an embodiment, the processor 702 may include a mobile optimized processor such as optimized for power consumption and mobile applications. The I/O interfaces 704 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 706 enables wireless communication to an external access device or network. Any number of suitable wireless data communication protocols, techniques, or methodologies can be supported by the radio 706, including any protocols for wireless communication. The data store 708 may be used to store data. The data store 708 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media.

Again, the memory 710 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 710 may incorporate electronic, magnetic, optical, and/or other types of storage media. Note that the memory 710 may have a distributed architecture, where various components are situated remotely from one another, but can be accessed by the processor 702. The software in memory 710 can include one or more software programs, each of which includes an ordered listing of executable instructions for implementing logical functions. In the example of FIG. 7, the software in the memory 710 includes a suitable operating system 714 and programs 716. The operating system 714 essentially controls the execution of other computer programs and provides scheduling, input-output control, file and data management, memory management, and communication control and related services. The programs 716 may include various applications, add-ons, etc. configured to provide end user functionality with the user device 700. For example, example programs 716 may include, but not limited to, a web browser, social networking applications, streaming media applications, games, mapping and location applications, electronic mail applications, financial applications, and the like. In a typical example, the end-user typically uses one or more of the programs 716 along with a network, such as the cloud-based system 500 (FIG. 5).

Again, embodiments of the disclosed systems and methods facilitate monitoring for specific external noises relevant to operation of the vehicle and providing dynamic non-audio indicators representing details about the noises such as the positions and/or characteristics of the causes of the sounds. Generally, environmental data provided from one or more vehicle environmental sensors is utilized to determine the current position of a sound source and sensed or predicted changes in the position of the sound source. One or more non-auditory interfaces of the vehicle such as screens, touch screens, head-up displays, instrument panels, haptic feedback devices, or the like are utilized to indicate the current position of the sound source, a sensed updated position of the sound source, a predicted updated position of the sound source, or a combination thereof in real-time such that an operator unable to hear the sound may react in a suitable fashion. In an exemplary embodiment, a suitable schematic representation is displayed including an indicator illustrating the position of the source of sound relative to the vehicle. The indicator may be updated based on sensed or predicted changes in the position or characteristics of the sound or source of sound. Alternatively, additional indicators may be generated based on such updates such that a route of the source of sound and/or previous characteristics of the sound are indicated. Furthermore or in different embodiments, video feeds of the current position of the source of sound, the updated position of the source of sound, and/or a predicted next position of the source of sound may be provided by the same or different non-auditory interfaces in addition to or as an alternative to the schematic representation including the indicator. Such video feeds may also be updated dynamically and/or in real time such that an operator unable to hear the sound may react in a suitable fashion.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following, non-limiting Claims for all purposes.

What is claimed is:

1. A system for dynamic tracking of sounds in a vicinity of a vehicle, the system comprising:
at least one memory storing instructions that, when executed by one or more processors, cause the one or more processors to:
determine, based on signals communicated from a plurality of environmental sensors supported relative to the vehicle, a current position of a source of a sound relative to the vehicle;
indicate via at least one non-auditory interface of the vehicle the current position of the source of the sound relative to the vehicle,
determine an updated position of the source of sound relative to the vehicle based on at least one of a predicted change in the position of the sound source or a sensed change in the position of the source of sound, and
indicate via the at least one non-auditory interface of the vehicle the updated position of the source of sound relative to the vehicle.

2. The system of claim 1, wherein the instructions executed by the one or more processors further cause the one or more processors to display via a first media element and the at least one non-auditory interface at least one video feed of the vicinity of the vehicle, and
wherein indicating the current position of the source of sound relative to the vehicle comprises displaying via a second media element and the at least one non-auditory interface at least one video feed indicating the current position of the source of sound relative to the vehicle in more detail than the at least one video feed of the vicinity of the vehicle.

3. The system of claim 2, wherein indicating the updated position of the source of sound relative to the vehicle comprises displaying via the second media element and the at least one non-auditory interface an additional video feed indicating the updated position of the sound source relative to the vehicle in more detail than the at least one video feed of the vicinity of the vehicle.

4. The system of claim 3, wherein the instructions executed by the one or more processors further cause the one or more processors to:
determine, subsequent to determining the updated position of the source of sound based on the sensed change in the position of the source of sound, a further updated position of the source of sound relative to the vehicle based on at least one of a further predicted change in the position of the sound source or a further sensed change in the position of the source of sound;
replace the additional video feed of the second media element indicating the previously determined updated position of the sound source relative to the vehicle with a further video feed indicating the further updated position of the sound source relative to the vehicle in more detail than the at least one video feed of the vicinity of the vehicle;
replace the at least one video feed of the second media element indicating the previously determined current position of the source of sound relative to the vehicle with the additional video feed indicating the previously determined updated position of the sound source relative to the vehicle; and
display via the second media element and the at least one non-auditory interface the at least one video feed indicating the previously determined current position of the source of sound relative to the vehicle.

5. The system of claim 2, wherein the instructions executed by the one or more processors further cause the one or more processors to:
display via the second media element and the at least one non-auditory interface at least one video feed indicating a previously determined position of the source of sound relative to the vehicle in more detail than the at least one video feed of the vicinity of the vehicle.

6. The system of claim 1, wherein the plurality of environmental sensors includes at least one of a microphone, an acoustic sensor, a vibrational sensor, a camera, or an optical sensor.

7. The system of claim 1, wherein the at least one non-auditory interface comprises at least one of a haptic feedback device on a steering wheel of the vehicle, an infotainment display of the vehicle, an instrument panel of the vehicle, or a heads-up display of the vehicle.

8. The system of claim 1, wherein indicating the current position of the source of sound relative to the vehicle comprises generating, based on the determined current position of the source of the sound source, an indicator via the non-auditory interface of the vehicle, the indicator indicating the determined current position of the source of sound relative to the vehicle.

9. The system of claim 8, wherein indicating the updated position of the source of sound relative to the vehicle comprises updating the indicator provided by the non-auditory interface of the vehicle such that the updated indicator indicates at least one of a predicted updated position of the sound source relative to the vehicle or a sensed updated position of the sound source relative to the vehicle.

10. The system of claim 9, wherein at least one of the indicator or the updated indicator indicates that the source of sound is at least one of an emergency vehicle, a horn of another vehicle, or a motorcycle.

11. The system of claim 1, wherein the instructions executed by the one or more processors further cause the one or more processors to generate the predicted updated position of the sound source based at least in part on the determined current position of the source of sound and a determined previous position of the source of sound, and wherein the indicator is updated based, at least in part, on the predicted updated position of the sound source.

12. The system of claim 1, wherein the instructions executed by the one or more processors further cause the one or more processors to generate the sensed updated position of the sound source based at least in part on subsequent signals communicated from the plurality of environmental sensors.

13. The system of claim 1, wherein the instructions executed by the one or more processors further cause the one or more processors to:
identify that the source of sound is within the vicinity of the vehicle based on signals communicated from at least one environmental sensor of the plurality of environmental sensors, and
wherein the current position of the sound source is determined based on signals communicated from at least one additional environmental sensor of the plurality of environmental sensors with respect to the at least one environmental sensor utilized to identify that the source of sound is within the vicinity of the vehicle.

14. The system of claim 1, wherein the signals communicated from the plurality of environmental sensors indicate sounds or audio data communicated from at least one of a microphone, an acoustic sensor, or a vibrational sensor.

15. The system of claim 1, wherein the instructions executed by the one or more processors further cause the one or more processors to select, based on the signals communicated from the plurality of environmental sensors, the sound from a plurality of sounds in the vicinity of the vehicle.

16. The system of claim 15, wherein the sound is selected based on at least one of an importance of an event associated with generation of the sound or the source of sound.

17. A vehicle comprising:
a plurality of environmental sensors supported relative to the vehicle;
at least one memory storing instructions configured to dynamically track sounds in a vicinity of the vehicle, the instructions, when executed by one or more processors, cause the one or more processors to:
determine, based on signals communicated from the plurality of environmental sensors, a current position of a source of a sound relative to the vehicle;
indicate via at least one non-auditory interface of the vehicle the current position of the source of the sound relative to the vehicle,
determine an updated position of the source of sound relative to the vehicle based on at least one of a predicted change in the position of the sound source or a sensed change in the position of the source of sound, and
indicate via the at least one non-auditory interface of the vehicle the updated position of the source of sound relative to the vehicle.

18. The vehicle of claim 17, wherein the instructions executed by the one or more processors further cause the one or more processors to display via a first media element and the at least one non-auditory interface at least one video feed of the vicinity of the vehicle, and
wherein indicating the current position of the source of sound relative to the vehicle comprises displaying via a second media element and the at least one non-auditory interface at least one video feed indicating the current position of the source of sound relative to the vehicle in more detail than the at least one video feed of the vicinity of the vehicle.

19. The vehicle of claim 18, wherein indicating the updated position of the source of sound comprises displaying via the second media element and the at least one non-auditory interface an additional video feed indicating the updated position of the sound source relative to the vehicle in more detail than the at least one video feed of the vicinity of the vehicle.

20. The vehicle of claim 17, wherein,
indicating the current position of the source of sound relative to the vehicle comprises generating, based on the determined current position of the source of the sound source, an indicator via the non-auditory interface of the vehicle, the indicator indicating the determined current position of the source of sound relative to the vehicle, and
wherein indicating the updated position of the source of sound relative to the vehicle comprises updating the indicator provided by the non-auditory interface of the vehicle such that the updated indicator indicates at least one of a predicted updated position of the sound source relative to the vehicle or a sensed updated position of the sound source relative to the vehicle.
